(19) United States
(12) Patent Application Publication
(10) Pub. No.: US 2026/0067131 A1
(43) Pub. Date: Mar. 5, 2026

(54) METHOD FOR RADIO UNIT, RADIO UNIT, AND BASE STATION SYSTEM

(71) Applicant: NEC Corporation, Tokyo (JP)

(72) Inventor: Prakash CHAKI, Tokyo (JP)

(73) Assignee: NEC Corporation, Tokyo (JP)

(21) Appl. No.: 19/309,896

(22) Filed: Aug. 26, 2025

(30) Foreign Application Priority Data
Sep. 2, 2024 (JP) 2024-150560

(51) Int. Cl. H04L 25/02; H04B 7/06; H04L 5/00

(52) U.S. Cl. CPC H04L 25/0204; H04B 7/0617; H04L 5/0051; H04L 25/0224

(57) ABSTRACT

In an example method, a Radio Unit (RU) performs low physical layer signal processing, communicates via a fronthaul interface with a Distributed Unit (DU) configured to perform high physical layer signal processing, and performs channel estimation and channel prediction.

### INCORPORATION BY REFERENCE

This application is based upon and claims the benefit of priority from Japanese patent application No. 2024-150560, filed on Sep. 2, 2024, the disclosure of which is incorporated herein in its entirety by reference.

### TECHNICAL FIELD

The present disclosure relates to functional splitting of a base station in a radio communication network.

### BACKGROUND ART

The Open Radio Access Network (O-RAN) Alliance is a community of mobile operators, vendors, and research and academic institutions, and its mission is to re-shape radio access networks (RANs) to be more intelligent, open, virtualized and fully interoperable. The O-RAN Alliance provides O-RAN technical specifications that define a standardized Open RAN architecture and interfaces. The standardization of interfaces by the O-RAN Alliance is building on the foundation set by the 3rd Generation Partnership Project (3GPP (registered trademark)).

The open interfaces specified in the O-RAN technical specifications include an open fronthaul interface between an O-RAN radio unit (O-RU) and an O-RAN distributed unit (O-DU) (see Non-Patent Literature 1). The open fronthaul interface between an O-RU and an O-DU is a logical interface, also known as a lower layer split (LLS).

The current O-RAN technical specifications support the split option 7-2x among the different LLS options and specify two variants, Category A and Category B (see, for example, Non-Patent Literature 1, section 4.2). The split option 7-2x is an option belonging to Option 7, an intra-physical (PHY) layer split, where low PHY layer functions are placed in the O-RU and high PHY layer functions and Radio Link Control (RLC) and Medium Access Control (MAC) functions are placed in the O-DU. Category A and Category B differ in the placement of downlink precoding. In Category A, the precoding function is placed above the open fronthaul interface, i.e., in the O-DU, whereas in Category B, the precoding function is placed below the open fronthaul interface, i.e., in the O-RU.

According to the intra-PHY layer function split in the split option 7-2x for 5th Generation (5G) New Radio (NR) downlink, especially for the Physical Downlink Shared Channel (PDSCH), scrambling, modulation, layer mapping, and resource element (RE) mapping are placed in the O-DU. Meanwhile, digital beamforming, inverse fast Fourier Transform (IFFT), and cyclic prefix (CP) addition are placed in the O-RU. Furthermore, for Category A O-RUs, precoding is performed in the O-DU and beamforming in the O-RU excludes the precoding calculation. In contrast, for Category B O-RUs, precoding is performed in the O-RU. In this case, precoding may be included in the digital beamforming processing block in the O-RU.

According to the intra-PHY layer function split in the split option 7-2x for 5G NR uplink, especially for the Physical Uplink Shared Channel (PUSCH), FFT, and CP removal are placed in the O-RU. Meanwhile, RE demapping, equalization, (PUSCH Demodulation Reference Signal (DMRS)-based) channel estimation, demodulation, and descrambling are placed in the O-DU. In addition, for the uplink Sounding Reference Signal (SRS), FFT and CP removal are placed in the O-RU, while RE demapping and (SRS-based) channel estimation are placed in the O-DU. The results of the SRS-based channel estimation can be used for either or both of precoding and beamforming for downlink transmission, e.g., PDSCH transmission using reciprocity-based beamforming approach. The results of SRS-based channel estimation can also be used for uplink beamforming, for e.g. in PUSCH.

In June 2023, the O-RAN Alliance agreed on two new open fronthaul interfaces optimized for the uplink in massive multiple-input multiple-output (mMIMO) deployments.

These new interfaces are referred to as Next-Generation LLS (NG-LLS) or Uplink Performance Improvement (ULPI) interfaces. The new interfaces are intended to improve mMIMO uplink performance in the current Category B O-RU or Category B split. One of the two new interfaces is called NG-LLS Class A, Category B ULPI-A, or 7.2x ULPI with DMRS-EQ. The other of the two new interfaces is referred to as NG-LLS Class B, Category B ULPI-B, or 7.2x ULPI with DMRS-NEQ.

NG-LLS Class A and NG-LLS Class B have in common that the uplink DMRS channel estimation and the uplink beamforming weight calculation are placed in the O-RU. On the other hand, the main difference between NG-LLS Class A and NG-LLS Class B is that the NG-LLS Class A specification places the equalizer function in the O-RU, while the NG-LLS Class B specification places it in the O-DU.

### Non-Patent Literature

Non-Patent Literature 1: O-RAN ALLIANCE Working Group 4, “Control, User and Synchronization Plane Specification 14.0”, O-RAN. WG4.CUS.0-R003-v14.00, February 2024

### SUMMARY

The functional split of a base station is found to have various technical problems and room for improvement. A base station may be referred to by other terms such as RAN node, radio station, or access point. One of these problems relates to functional splits suitable for SRS-based beamforming to improve mMIMO downlink performance. In particular, it is not clear which logical unit within the O-RAN, specifically the O-RU, the O-DU, the O-CU, or the Near-Real-Time (RT) RAN Intelligent Controller (RIC), is appropriate to contain a channel prediction function. Determining the appropriate architecture may have an impact on the control plane (C-plane) traffic since the fronthaul interface between a O-DU and O-RU may have strict latency requirement. Furthermore, such architecture can also impact the throughput performance.

In 5G NR, SRS is an uplink reference signal configured on a user equipment (UE)-specific basis. SRS is used by a base station (e.g., gNB, O-DU) for uplink channel sounding, i.e., uplink channel estimation between a UE and a base station (e.g., O-RU, gNB). In the uplink, the results of SRS-based uplink channel estimation can be used for purposes including but not limited to uplink beamforming weight (for example, at least one of a codebook or non-codebook type beamforming) calculation, link adaptation, rank adaptation, channel-dependent scheduling, timing control, and beam management. Furthermore, in the downlink (for example, in the downlink of a time-division duplex (TDD) system), SRS-based uplink channel estimation can be used for purposes including but not limited to reciprocity-based downlink precoding weight (or beamforming weight) calculation (for example, at least one of a codebook or non-codebook type beamforming), link adaptation, rank adaptation, and channel-dependent scheduling. Furthermore, there can be other uses and applications of SRS-based uplink channel estimation which are not listed here, but can be understood to improve a system performance.

If SRS-based uplink channel estimation is used for at least one of an uplink beamforming weight calculation, and a downlink beamforming weight calculation (leveraging the channel reciprocity of TDD) then a channel prediction function can improve the beamforming performance. A channel prediction operation may enable a base station to obtain predicted value of channel estimate in the time slot where recent value of channel estimate is not available.

For example, consider an uplink scenario. A base station may compute the uplink beamforming matrix in a time slot where SRS is received. Then the base station may continue to use this same uplink beamforming matrix for all subsequent PUSCH slots till the time a next SRS is received. The use of this outdated uplink beamforming matrix may degrade the uplink throughput. Similarly, consider the case of a reciprocity-based downlink beamforming using SRS. A base station may compute the downlink beamforming matrix in a time slot where SRS is received. Then the base station may continue to use this same downlink beamforming matrix for all PDSCH slots till the time a next SRS is received. The use of this outdated downlink beamforming matrix may degrade the downlink throughput.

Note that, updated values of the uplink channel estimate can be obtained by frequent transmission of SRS in the uplink which can result in pilot overhead, thus reducing the opportunity for transmission of data (PUSCH) signal and reducing uplink throughput. In contrast, a channel prediction operation may use past values of channel estimates (computed from received uplink SRS), and then use those past values for predicting or extrapolating the channel estimate in a time slot where no SRS transmission is scheduled (for example, in a PUSCH or PDSCH transmission slot). SRS-based channel prediction includes temporal prediction using the results of SRS-based channel estimation. SRS-based channel prediction can be a prediction of future channel characteristics using the results of past SRS-based channel estimation.

The placement of the channel prediction function is not currently covered in the NG-LLS discussions in the O-RAN Alliance. Hence, it is an important technical problem to decide the appropriate position of a channel prediction function in the O-RAN NG-LLS architecture that can support the efficient operation of beamforming in at least one of an uplink and downlink.

Another problem relates to the placement of the function of dynamically allocating SRS resources to UEs. In particular, it is not clear which logical unit within the O-RAN, specifically the O-RU, the O-DU, the O-CU, or the Near-RT RIC, is appropriate to have the dynamic SRS resource allocation function. Furthermore, or alternatively, it is not clear what signaling exchange is required between a logical unit with dynamic SRS resource allocation capability and another logical unit.

An example object to be achieved by the example embodiments disclosed herein is to provide apparatuses, methods, and/or programs that contribute to solving at least one of a plurality of problems related to functional splitting of a base station, including the problems described above. It should be noted that this object is merely one of the objects to be achieved by the example embodiments disclosed herein. Other objects or problems and novel features will become apparent from the following description and the accompanying drawings.

In a first example aspect, a base station system includes an RU configured to perform low physical layer signal processing, a DU configured to perform high physical layer signal processing, and a controller configured to perform near-real-time control of RAN elements and resources, including at least the DU. In addition, one of the RU, the DU, and the controller is configured to perform both channel estimation and channel prediction.

In a second example aspect, an RU is configured to: (a) perform low physical layer signal processing, and (b) communicate via a fronthaul interface with a DU configured to perform high physical layer signal processing. In addition, the RU is configured to perform channel estimation and channel prediction.

In a third example aspect, a method performed by an RU includes: (a) performing low physical layer signal processing, (b) communicating via a fronthaul interface with a DU configured to perform high physical layer signal processing, and (c) performing channel estimation and channel prediction.

In a fourth example aspect, a method includes manufacturing one of an RU, a DU, and a controller to perform both channel estimation and channel prediction.

In a fifth example aspect, a DU is configured to: (a) communicate via a fronthaul interface with an RU configured to perform low physical layer signal processing; (b) perform high physical layer signal processing; and (c) perform at least one of uplink scheduling and downlink scheduling. In addition, the DU is configured to receive information indicating a dynamically determined uplink SRS resource allocation for a UE from the RU or a CU configured to perform dynamic uplink SRS resource allocation.

In a sixth example aspect, a method performed by a DU includes: (a) communicating via a fronthaul interface with an RU configured to perform low physical layer signal processing; (b) performing high physical layer signal processing; (c) performing at least one of uplink scheduling and downlink scheduling; and (d) receiving information indicating a dynamically determined uplink SRS resource allocation for a UE from the RU or a CU configured to perform dynamic uplink SRS resource allocation.

In a seventh example aspect, an RU is configured to: (a) perform low physical layer signal processing, and (b) communicate via a fronthaul interface with a DU configured to perform high physical layer signal processing. In addition, the RU is configured to dynamically allocate uplink SRS resources to a UE. The RU is further configured to send information indicating an uplink SRS resource allocation for the UE to the DU configured to perform at least one of uplink scheduling and downlink scheduling.

In an eighth example aspect, a method performed by an RU includes: (a) performing low physical layer signal processing; (b) communicating via a fronthaul interface with a DU configured to perform high physical layer signal processing; (c) dynamically allocating uplink SRS resources to a UE; and (d) sending information indicating an uplink SRS resource allocation for the UE to the DU configured to perform at least one of uplink scheduling and downlink scheduling.

In a ninth example aspect, a DU is configured to: (a) communicate via a fronthaul interface with an RU configured to perform low physical layer signal processing; (b) perform high physical layer signal processing; and (c) perform at least one of uplink scheduling and downlink scheduling. In addition, the DU is configured to send information indicating at least one of an uplink resource allocation and a downlink resource allocation for a UE to the RU or a CU configured to perform dynamic uplink SRS resource allocation to the UE.

In a tenth example aspect, a method performed by a DU includes: (a) communicating via a fronthaul interface with an RU configured to perform low physical layer signal processing; (b) performing high physical layer signal processing; (c) performing at least one of uplink scheduling and downlink scheduling; and (d) sending information indicating at least one of an uplink resource allocation and a downlink resource allocation for a UE to the RU or a CU configured to perform dynamic uplink SRS resource allocation to the UE.

In an eleventh example aspect, an RU is configured to: (a) perform low physical layer signal processing, and (b) communicate via a fronthaul interface with a DU configured to perform high physical layer signal processing. In addition, the RU is configured to dynamically allocate uplink SRS resources to a UE. The RU is further configured to receive information from the DU indicating at least one of an uplink resource allocation and a downlink resource allocation to the UE.

In a twelfth example aspect, a method performed by an RU includes: (a) performing low physical layer signal processing; (b) communicating via a fronthaul interface with a DU configured to perform high physical layer signal processing; (c) dynamically allocating uplink SRS resources to a UE; and (d) receiving information from the DU indicating at least one of an uplink resource allocation and a downlink resource allocation to the UE.

In a thirteenth example aspect, a program includes a set of instructions (or software codes) that, when loaded into a computer, causes the computer to perform the method according to one of the example aspects described above (e.g., the sixth or tenth example aspect).

### BRIEF DESCRIPTION OF DRAWINGS

The above and other aspects, features, and advantages of the present invention will become more apparent from the following description of certain example embodiments when taken in conjunction with the accompanying drawings, in which:

FIG. 1 shows an O-RAN logical architecture related to one or more example embodiments;

FIG. 2 shows an example configuration of an O-DU, an O-CU Control Plane (CP), an O-CU User Plane (UP), and a Near-RT RIC related to one or more example embodiments;

FIG. 3 shows an example configuration of an O-RU related to one or more example embodiments;

FIG. 4A shows an operation of uplink transmission from a UE to a base station in a wireless communication system to which an example embodiment of the present disclosure is applied;

FIG. 4B shows an operation of downlink transmission from base station to UE in a wireless communication system to which an example embodiment of the present disclosure is applied;

FIG. 4C shows an example of a problem of calculation of downlink beamforming weights that causes channel aging in a wireless communication system to which an example embodiment of the present disclosure is applied;

FIG. 4D shows an example of channel prediction to mitigate channel aging in a wireless communication system to which an example embodiment of the present disclosure is applied;

FIG. 4E shows an example of a problem in channel prediction in a wireless communication system to which an example embodiment of the present disclosure is applied;

FIG. 4F shows an example of eigenvector prediction to mitigate channel aging in a wireless communication system to which an example embodiment of the present disclosure is applied;

FIG. 4G shows a functional configuration of a base station with channel predictor, to which an example embodiment of the present disclosure is applied;

FIG. 4H shows a functional configuration of a base station with eigenvector predictor, to which an example embodiment of the present disclosure is applied;

FIG. 5A shows an example of a functional split of a base station in relation to one or more example embodiments;

FIG. 5B shows an example of a functional split of a base station in relation to one or more example embodiments;

FIG. 5C shows an example of a functional split of a base station in relation to one or more example embodiments;

FIG. 5D shows an example of a functional split of a base station in relation to one or more example embodiments;

FIG. 5E shows an example of a functional split of a base station in relation to one or more example embodiments;

FIG. 5F shows an example of a functional split of a base station in relation to one or more example embodiments;

FIG. 6A shows examples of a functional split and signalling of a base station relevant to one or more example embodiments;

FIG. 6B shows examples of a functional split and signalling of a base station relevant to one or more example embodiments;

FIG. 7A shows an example of a message for communication between functional splits in an embodiment of the present disclosure;

FIG. 7B shows an example of a message for communication between functional splits in an embodiment of the present disclosure; and

FIG. 7C shows an example of a message for communication between functional splits in an embodiment of the present disclosure.

### EXAMPLE EMBODIMENT

Specific example embodiments will be described hereinafter in detail with reference to the drawings. The same or corresponding elements are denoted by the same symbols throughout the drawings, and duplicated explanations are omitted as necessary for the sake of clarity.

The plurality of example embodiments described below may be implemented independently or in combination, as appropriate. These example embodiments include novel features that are different from one another. Accordingly, these example embodiments contribute to the achievement of objectives or the solution of problems that are different from one another and contribute to the achievement of advantages that are different from one another.

Each of the drawings or figures is merely an example to illustrate one or more example embodiments. Each figure may not be associated with only one particular example embodiment, but may be associated with one or more other example embodiments. As will be appreciated by those of ordinary skill in the art, various features or steps described with respect to any one of the figures may be combined with features or steps illustrated in one or more other figures to produce, for example, example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The multiple example embodiments shown below are primarily described for radio communication systems that comply with the 3GPP 5G NR technical specifications and the O-RAN technical specifications. However, these example embodiments may be applied to other radio communication systems that support similar technologies. In particular, these example embodiments may be applied to future Beyond 5G or 6G systems and to radio communication systems that comply with future enhanced O-RAN technical specifications.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

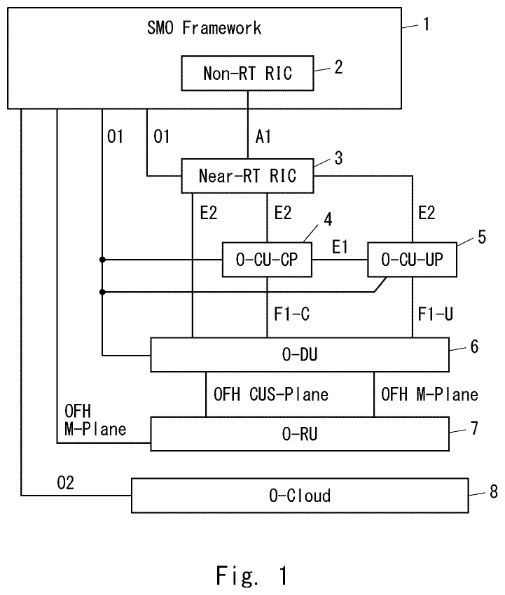

First, the configurations and operations of a plurality of network elements common to a plurality of example embodiments are described. FIG. 1 illustrates an example configuration of a radio communication system including one or more base stations, related to a plurality of example embodiments. As noted above, a base station may be referred to by other terms such as RAN node, radio station, or access point. In particular, a base station that includes multiple logical or physical elements with functional splits may be referred to as a base station system, a RAN node system, a radio station system, or an access point system. For example, without limitation, a base station may be a gNB in a 5G system. In the example in FIG. 1, the radio communication system conforms to the O-RAN logical architecture. In the example in FIG. 1, the system includes a Service Management and Orchestration (SMO) framework 1, a Non-RT RIC 2, a Near-RT RIC 3, an O-CU Control Plane (CP) 4, an O-CU User Plane (UP) 5, an O-DU 6, an O-RU 7, and an O-Cloud 8. Each element (network function) shown in FIG. 1 may be implemented, for example, as a network element on dedicated hardware, as a software instance running on dedicated hardware, or as a virtualized function instantiated on an application platform.

The SMO Framework 1 can be referred to simply as SMO. The SMO framework 1 provides various logical functions that are not anchored in the Non-RT RIC 2. These logical functions include, but are not limited to, O1 termination, O2 termination, Open Fronthaul (OFH) management plane (M-plane) termination, and external terminations. The O1 termination allows the SMO Framework 1 to exchange messages on the O1 interface with the Near-RT RIC 3 and with E2 nodes such as the O-CU-CP 4, the O-CU-UP 5, and the O-DU 6. The O2 termination allows the SMO Framework 1 to exchange messages with the O-Cloud 8 on the O2 interface.

The O-Cloud 8 is a cloud computing platform consisting of a collection of physical infrastructure nodes that meet O-RAN requirements to host relevant O-RAN functions, supporting software components, and appropriate management and orchestration functions. The relevant O-RAN functions include, for example, the Near-RT RIC 3 and E2 nodes. The OFH M-plane termination allows the SMO framework 1 to communicate with the O-RU 7 for non-real-time management operations related to the open fronthaul. The external terminations allow the SMO Framework 1 or the Non-RT RIC 2 to exchange messages with external entities via interfaces outside the scope of the O-RAN.

The Non-RT RIC 2 is a logical function within the SMO Framework 1. The Non-RT RIC 2 consists of a Non-RT RIC framework and Non-RT RIC applications (rApps). The Non-RT RIC framework includes functionality to logically terminate the A1 interface and expose a set of R1 services to rApps. The A1 termination allows the Non-RT RIC framework and the Near-RT RIC 3 to exchange messages on the A1 interface. The set of R1 services includes A1-related services and O1-related services, and other services. Typical execution times for use cases involving non-real-time control loops by the Non-RT RIC 2 or between the Non-RT RIC 2 and the Near-RT RIC 3, E2 nodes, and O-RU 7 are 1 second or more.

The A1-related services include, among others, creating, updating, querying, and deleting A1 policies; querying the enforcement status of A1 policies; and subscribing to event notifications about A1 policies, including notifications of changes in the enforcement status of A1 policies.

The O1-related services are provided by the SMO framework1 and the Non-RT RIC framework. The O1-related services allow rApps to obtain information about alarms, obtain performance information related to the network, obtain the current configuration of the network, provision changes to the network configuration, and obtain additional information related to the network.

The Near-RT RIC 3 is a logical function that enables near-real-time control and optimization of RAN elements and resources via fine-grained (e.g., UE basis, Cell basis) data collection and actions over the E2 interface. Typical execution times for use cases involving near-real-time control loops by the Near-RT RIC 3 or between the Near-RT RIC 3 and E2 nodes are on the order of 10 ms to 1 second.

The Near-RT RIC 3 hosts a set of applications called xApps and provides a set of platform functions that are commonly used to support specific functions hosted by xApps. The set of platform functions includes database and shared data layer (SDL), xApp subscription management, conflict mitigation, messaging infrastructure, interface termination, and application programming interface (API) enablement. The Interface Termination includes E2 termination, A1 termination, and O1 termination, which provide termination of the E2 interface, the A1 interface, and the O1 interface, respectively.

The E2 interface connects the Near-RT RIC 3 to one or more E2 nodes. An E2 node is a logical node that terminates the E2 interface. An E2 node is a RAN node that exposes one or more RAN functions to the Near-RT RIC 3 and hosted xApps. For NR access, E2 nodes include the O-CU-CP 4, the O-CU-UP 5, and the O-DU 6, as shown in FIG. 1. Control loops in an E2 node such as the O-CU-CP 4, the O-CU-UP 5, or the O-DU 6 are typically operable in less than 10 milliseconds. (e.g., radio scheduling in the O-DU 6).

The O-CU-CP 4 is a logical node that hosts the control plane functions of a gNB-CU as specified in the 3GPP technical specifications, in particular the Radio Resource Control (RRC) and the control plane part of the Packet Data Convergence Protocol (PDCP). The O-CU-CP 4 supports E1 Application Protocol (E1AP) signaling on the E1 interface between a gNB-CU-CP and a gNB-CU-UP as specified in the 3GPP technical specifications in order to communicate with the O-CU-UP 5. The O-CU-CP 4 supports F1AP signaling on the F1-C interface between a gNB-CU-CP and a gNB-DU as specified in the 3GPP technical specifications in order to communicate with the O-DU 6. The O-CU-CP 4 provides E2 interface termination to communicate with the Near-RT RIC 3. In addition, the O-CU-CP 4 provides O1 interface termination to communicate with the SMO Framework 1.

The O-CU-UP 5 is a logical node that hosts the user plane functions of a gNB-CU as specified in the 3GPP technical specifications, in particular the user plane part of the PDCP and the Service Data Adaptation Protocol (SDAP). The O-CU-UP 5 supports E1AP signaling as specified in the 3GPP technical specifications to communicate with the O-CU-CP 4. The O-CU-UP 5 supports the F1-U interface as specified in the 3GPP technical specifications to communicate with the O-DU 6. The F1-U interface uses the General Packet Radio Service Tunnelling Protocol User Plane (GTP-U) protocol. The GTP-U protocol uses a GTP-U tunnel to carry encapsulated user data packets and signaling messages. The O-CU-UP 5 provides E2 interface termination to communicate with the Near-RT RIC 3. In addition, the O-CU-UP 5 provides O1 interface termination to communicate with the SMO Framework 1.

The O-DU 6 is a logical node that hosts the RLC and MAC layers of a gNB as specified in the 3GPP technical specifications, as well as part of the PHY layer of a gNB, i.e., the high PHY layer. The high PHY layer signal processing for 5G NR downlink, in particular for PDSCH, includes, for example, scrambling, modulation, layer mapping and RE mapping.

Precoding for downlink transmission may be performed in the O-DU 6 (i.e., Category A O-RU) or in the O-RU 7 (i.e., Category B O-RU).

The O-DU 6 supports the F1-C and F1-U interfaces as specified in the 3GPP technical specifications to communicate with the O-CU-CP 4 and the O-CU-UP 5. The O-DU 6 provides E2 interface termination to communicate with the Near-RT RIC 3. The O-DU 6 provides O1 interface termination to communicate with the SMO Framework 1. In addition, the O-DU 6 provides OFH interface termination to communicate with the O-RU 7. The OFH interface includes the OFH M-plane and the Control User Synchronization (CUS) plane.

The O-RU 7 is a logical node that hosts the rest of the PHY layer signal processing in a gNB, i.e., the low PHY layer. The low PHY layer signal processing for 5G NR downlink, in particular for PDSCH, includes, for example, digital beamforming, IFFT, and cyclic prefix (CP) addition. As mentioned above, precoding for downlink transmission may be performed in the O-DU 6 (i.e., Category A O-RU) or in the O-RU 7 (i.e., Category B O-RU). For Category B O-RUs, precoding may be included in the digital beamforming processing block in the O-RU 7.

The O-RU 7 provides OFH interface termination to communicate with the O-DU 6, which includes the OFH M-plane and CUS plane. In addition, the O-RU 7 provides OFH M-plane termination to communicate with the SMO framework 1.

The O-RU 7 also includes a digital front end (DFE) and a radio frequency (RF) front end (FE). Signal processing in the DFE includes, for example, digital pre-distortion (DPD), crest factor reduction (CFR), digital up-conversion (DUC), and digital down-conversion (DDC). The RF FE includes, for example, power amplifiers (PAs), low-noise amplifiers (LNAs), bandpass filters, digital-to-analog converters (DACs), and analog-to-digital converters (ADCs).

Part or all of the Near-RT RIC 3, O-CU-CP 4, O-CU-UP 5, and O-DU 6 can run on Commercial Off-The-Shelf (COTS) hardware or purpose-built hardware. Part or all of the RAN network functions provided by the Near-RT RIC 3, O-CU-CP 4, O-CU-UP 5 and O-DU 6 can be implemented on a virtualization or cloud platform such as the O-Cloud 8.

A virtualization or cloud platform, such as the O-Cloud 8, is a collection of hardware and software components that provide the computing power to perform virtualized RAN network functions. Virtualization or cloud platform hardware includes computing, networking, and storage components. Virtualization or cloud platform hardware is augmented with hardware accelerators as needed. Virtualization or cloud platform software provides application programming interfaces (APIs) to manage the lifecycle of virtualized RAN network functions. A virtualization or cloud platform may use virtual machines (VMs) orchestrated and managed with OpenStack (trademark) or containers orchestrated and managed with Kubernetes (trademark), or both, to implement virtualized (or containerized or cloudified) RAN network functions.

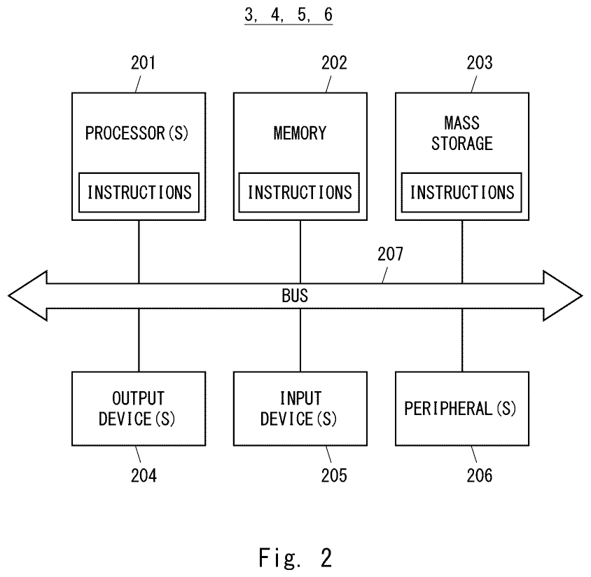

FIG. 2 shows an example configuration of the Near-RT RIC 3, O-CU-CP 4, O-CU-UP 5, and O-DU 6. In the example in FIG. 2, the Near-RT RIC 3, O-CU-CP 4, O-CU-UP 5, and O-DU 6 are implemented using a general-purpose computer system. The computer system includes one or more processors 201, a memory 202, and a mass storage 203 that communicate with each other over a bus 207. The one or more processors 201 may include, for example, one or more central processing units (CPUs), one or more graphics processing units (GPUs), or both. The computer system may include other devices such as one or more output devices 204, one or more input devices 205, and one or more peripherals 206. The one or more peripherals 206 may include a modem, or a network adapter, or both.

One or both of the memory 202 and the mass storage 203 include a computer-readable medium storing one or more sets of instructions. These instructions may be partially or wholly stored in memory in the one or more processors 201. These instructions, when executed in the one or more processors 201, cause the one or more processors 201 to provide the functions of THE NEAR-RT RIC 3, O-CU-CP 4, O-CU-UP 5, OR O-DU 6.

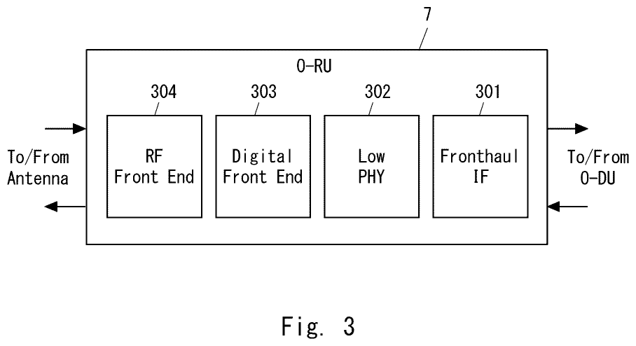

FIG. 3 shows an example configuration of the O-RU 7. The O-RU 7 is typically implemented using purpose-built hardware. This purpose-built hardware includes a fronthaul interface 301, a low PHY processor 302, DFE circuitry 303, and RF FE circuitry 304. The fronthaul interface 301 includes interface circuitry for open fronthaul transport. The low PHY processor 302 includes one or more dedicated processors for low PHY signal processing. The one or more dedicated processors may include one or more application-specific integrated circuits (ASICs), one or more field-programmable gate arrays (FPGAs), one or more digital signal processors (DSPs), or any combination thereof. The DFE circuitry 303 includes circuits that perform DFE processing, e.g., DPD, CFR, DUC, and DDC. The RF FE circuitry 304 includes, for example, PAs, LNAs, bandpass filters, DACs, and ADCs.

However, some of the functions or signal processing in the O-RU 7 may run on COTS hardware. For example, some or all of the low PHY layer signal processing placed in the O-RU 7 may run on COTS hardware, or may be implemented on a virtualization or cloud platform such as the O-Cloud 8.

In what follows next, several example embodiments are described. Note that, a channel prediction function described in this disclosure is not limited to using SRS-based channel estimates for channel prediction. More specifically, channel estimates obtained from any method, such as those obtained from a received reference (or pilot) signal, including but not limited to SRS and uplink DMRS, may be construed within the scope of the example embodiments. The channel prediction function can thus take as input the past values of channel estimates obtained from any method, such as those obtained from received reference signal including but not limited to SRS and uplink DMRS. Based on the input past values of channel estimates, the channel prediction function may be able to predict a new value of channel estimate. The predicted value of channel estimate may be able to improve the performance of the considered communication system in terms of one or more performance metrics (for e.g., system throughput in uplink or downlink transmission).

### First Example Embodiment

An example configuration of a radio communication system according to this example embodiment is similar to the configuration described with reference to FIG. 1-3. This example embodiment provides details on the placement of channel estimation and channel prediction in the functional split of a base station. In this example embodiment, the channel prediction is placed in the same logical unit as the channel estimation. Specifically, the channel prediction function, operation, processing block, or section is placed in the O-RU 7, O-DU 6, or Near-RT RIC 3 together with the channel estimation function, operation, processing block, or section. In other words, in this example embodiment, at least one of the O-RU 7, O-DU 6, and Near-RT RIC 3 is configured to perform both the channel estimation and the channel prediction. With respect to a method of manufacturing a base station system, the method includes manufacturing at least one of the O-RU 7, O-DU 6, and Near-RT RIC 3 to perform both the channel estimation and the channel prediction.

According to this arrangement, configuration, or manufacturing method, the signaling between the channel estimation processing block and the channel prediction processing block need not be transmitted on an interface between different logical units (e.g., OFH C-plane).

Thus, in cases where the channel prediction processing block is introduced in a base station system (e.g., gNB), the traffic increase on an interface between different logical units (e.g., OFH C-plane) can be reduced. It also helps to reduce latency in a control loop that includes channel prediction.

As mentioned above, in one example, the channel estimation may be based on one or more received uplink reference (or pilot) signals. In an example of channel estimation, the calculated channel estimate may comprise of at least an amplitude and a phase of a channel impulse response or channel frequency response. Such amplitude and/or phase may constitute a channel characteristic. There can be other channel characteristics which can be estimated by channel estimation. The channel prediction may use previous channel estimates obtained by the channel estimation based on the uplink reference signal(s) as its input and predict a new value of channel estimate. By way of example, not as a limitation, the uplink reference signal(s) may include either or both SRS and uplink DMRS.

As mentioned above, in 5G NR, SRS is an uplink reference signal configured on a UE-specific basis. SRS is used by a base station (e.g., gNB, O-DU 6) for uplink channel sounding, i.e., uplink channel estimation between a UE and a base station (e.g., O-RU 7, gNB). SRS-based channel estimation involves estimating channel characteristics between a UE and the O-RU 7 using the results of reception of SRS transmitted by the UE. In the uplink, the results of SRS-based uplink channel estimation can be used for purposes including but not limited to uplink beamforming weight (for example, at least one of a codebook or non-codebook type beamforming) calculation, link adaptation, rank adaptation, channel-dependent scheduling, timing control, and beam management. Furthermore, in the downlink (for example, in the downlink of a TDD system), SRS-based uplink channel estimation can be used for purposes including but not limited to reciprocity-based downlink precoding weight (or beamforming weight) calculation (for example, at least one of a codebook or non-codebook type beamforming), link adaptation, rank adaptation, and channel-dependent scheduling.

SRS-based beamforming, i.e., the calculation of precoding weights or beamforming weights using the results of SRS-based channel estimation, can use the results of SRS-based channel prediction. SRS-based channel prediction includes temporal prediction using the results of SRS-based channel estimation. SRS-based channel prediction can be a prediction of future channel characteristics using the results of past SRS-based channel estimation. Alternatively, the temporal prediction may predict eigenvectors for downlink transmission, precoding weights for downlink transmission, beamforming weights for downlink transmission, or downlink beams for downlink transmission. Additionally or alternatively, the temporal prediction may predict beamforming weights for uplink transmission. Such temporal prediction may be performed by performing inference on a trained artificial intelligence or machine learning model.

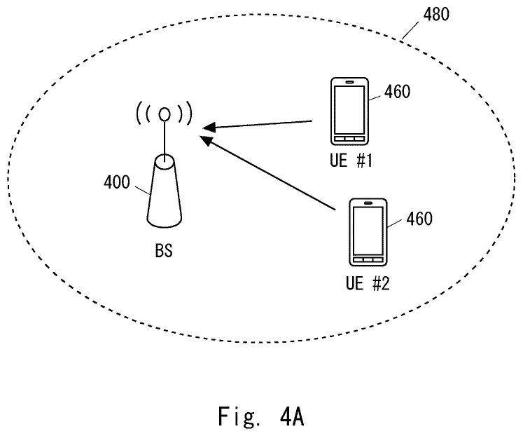

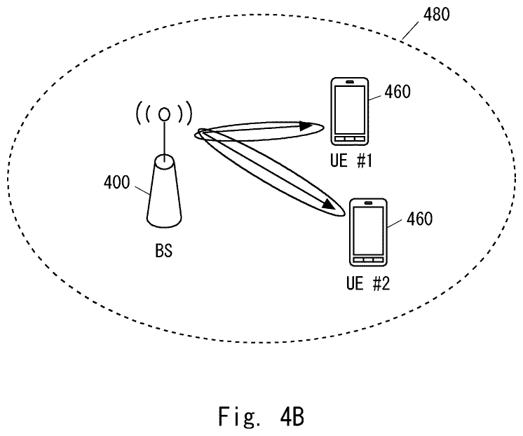

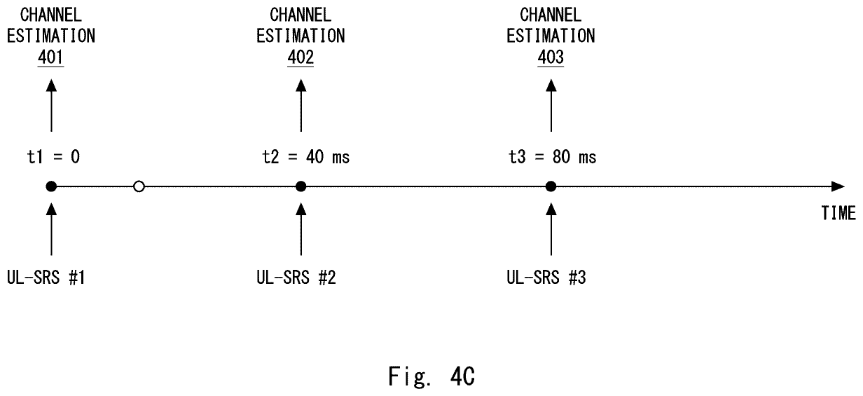

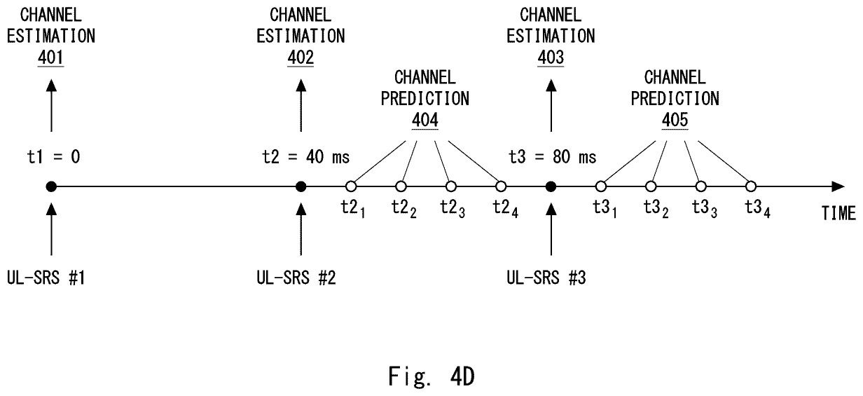

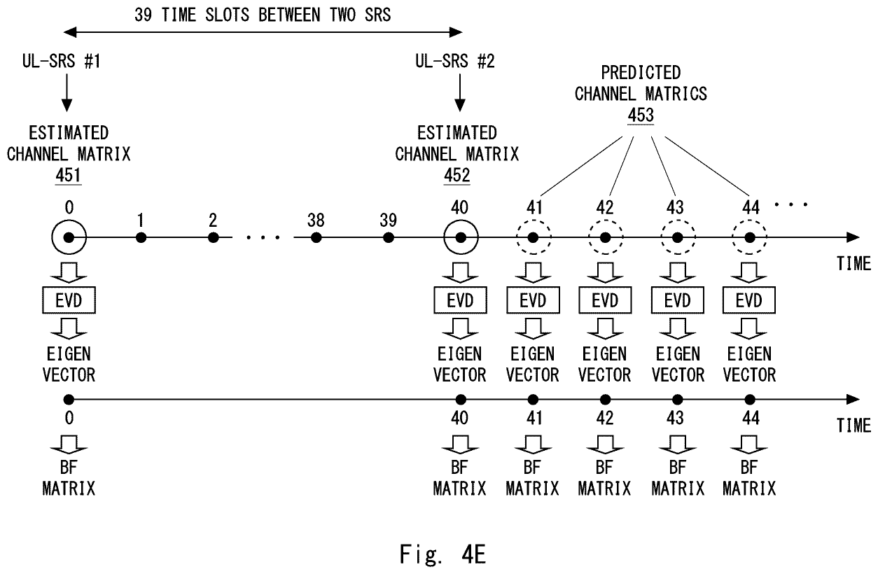

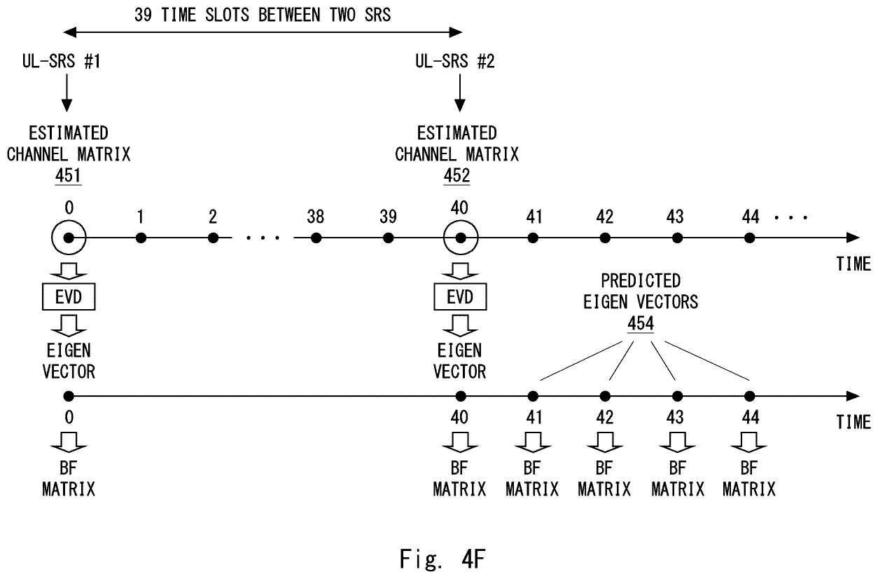

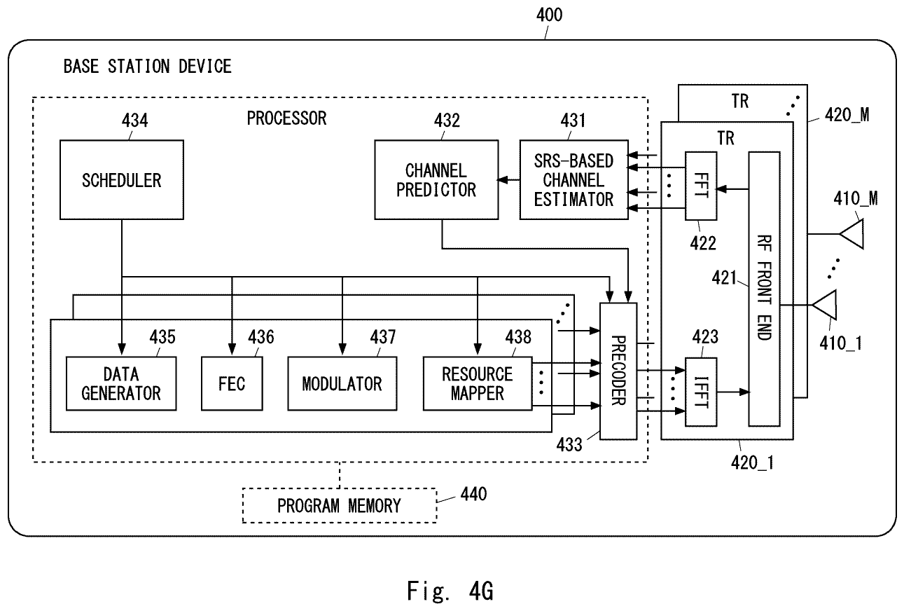

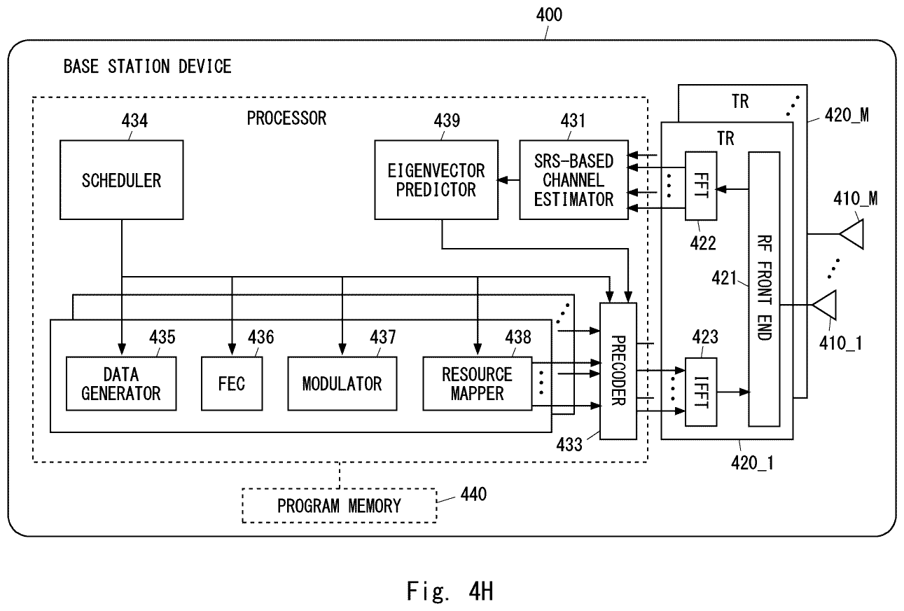

With reference to FIGS. 4A-4H, description of SRS-based channel estimation, channel prediction, and eigenvector prediction are provided using specific examples. Although the examples are provided using SRS as a reference signal, it is possible to extend the examples for the case of channel prediction based on uplink DMRS-based channel estimates.

As illustrated in FIGS. 4A and 4B, a wireless communication system is composed of a plurality of communication devices where a specific communication device such as a base station (BS) or an access point may communicate with other communication devices. For simplicity, it is assumed that a BS device 400 is capable of communicating with a plurality of UE terminals 460 including two UE terminals UE #1 and UE #2. The UE terminals UE #1 and UE #2 are located within a radio coverage area (e.g., cell) 480 formed by the BS 400, allowing each UE terminal to perform uplink (UL) transmission and the BS device 400 to perform downlink (DL) transmission with beamforming. The UL transmission may also use beamforming.

In FIG. 4C, the UE terminal 460 sends an uplink SRS (UL-SRS) to the BS device 400 at intervals of 40 milliseconds (ms). The BS device 400, each time receiving a UL-SRS, performs channel estimation 401, 402, or 403 and thereby calculates the digital beamforming (BF) weight, for example, at least one of an uplink beamforming weight or downlink beamforming weight. The SRS-based channel estimation method may include at least one of a least square (LS) channel estimation algorithm, a linear minimum mean square error (MMSE) channel estimation algorithm, a discrete Fourier transform (DFT)-based channel estimation algorithm, a discrete cosine transform (DCT)-based channel estimation algorithm or some other channel estimation algorithm. In an example of channel estimation, the amplitude and phase of a channel impulse response may be calculated.

The wireless channel between the BS device 400 and UE terminal 460 may vary with time due to the movement of the UE terminal 460, or for other reasons contributing to variation of wireless channel. If the condition of the wireless channel between the BS device 400 and the UE terminal 460 changes within a duration of 40 ms between t=0 (the time instant at which the UE terminal 460 sends UL-SRS #1 and BS device 400 receives it) and t=40 ms (the time instant at which the UE terminal 460 sends UL-SRS #2 and the BS device 400 receives it), the BS device 400 may not have accurate knowledge of the channel response between t=0 and t=40 ms. The phenomenon in which the estimated channel response becomes outdated or inaccurate over time due to various factors (for example, the mobility of users or changes in the environment) may be referred to as channel aging. In such a situation, the BS device 400 may have to reuse the beamforming weight calculated at the preceding channel estimation event till the next channel estimation event. For example, the BS device 400 may compute a channel estimate and beamforming weight at t=0, and may continue to use the same beamforming weight for downlink transmission till the next channel estimation event is performed at t=40 ms.

Accordingly, use of outdated channel estimation results and digital beamforming weights by the BS device 400 may result in performance (for example, throughput) degradation caused by factors such as inefficient interference cancellation between the spatially multiplexed streams and interference between signals destined for different UE terminals.

Although FIG. 4C is explained here using an example of channel estimation based on uplink SRS, the channel estimation can be based on another type of reference signal, such as uplink DMRS in another example. In such an example, the UE terminal 460 can send uplink DMRS to the BS device 400 during uplink transmission, for example, PUSCH or PUCCH transmission. Subsequently, the BS device 400 will extract the uplink DMRS symbols frequency-multiplexed with the data symbols in the PUSCH or PUCCH transmission, perform channel estimation based on the uplink DMRS, and then use it for calculation of at least one of an uplink beamforming weight and a downlink beamforming weight till the next event of channel estimation. The effect of channel aging may degrade the throughput performance of the system.

With reference to FIG. 4D, an example of channel prediction is described which can enhance the performance (for example, throughput performance) of a system employing SRS-based channel estimation. Here, the BS device 400 performs channel estimation 401 and 402 based on the received SRS from the UE terminal 460 at time t1=0 and t2=40 ms, similar to FIG. 4C. Then, the BS device 400 performs channel prediction 404 to compute a predicted channel response based on the estimated channel responses.

For instance, after receiving the UL-SRS #2 at the time instant t2, the BS device 400 computes channel responses at time instants t2₁, t2₂, . . . based on two or more channel responses obtained by the channel estimation (e.g., 401 and 402). After receiving the UL-SRS #3 at the time instant t3, the BS device 400 performs the channel prediction 405 again in the same manner. The extrapolation operation may be performed by at least one extrapolation method such as a linear extrapolation, linear regression, least-square estimation, non-linear regression, polynomial regression, spline regression and curve fitting, or by performing inference on a trained artificial intelligence or machine learning model. The example in FIG. 4D can be applied to an example that employs uplink DMRS-based channel estimation as well.

With reference to FIG. 4E, an example of channel prediction is described in the context of eigenvector decomposition (EVD) or singular value decomposition (SVD) based signal processing for precoding. A channel response matrix is predicted in the time slots where no channel estimation is performed. Subsequently, an SVD or EVD operation is performed to obtain the eigenvectors, which are then used for beamforming. For example, the BS device 400 may receive a first uplink SRS (SRS #1) at time slot=0, and a second SRS (SRS #2) at time slot=40 ms. Accordingly, channel estimation can be performed at time slot=0 and time slot=40 ms to obtain the corresponding estimated channel response matrices 451 and 452 at time slot=0 and time slot=40 ms, respectively. Let us consider that the next channel estimation is performed after SRS is received at time slot=80 ms (not shown in FIG. 4E). Then, for a time slot greater than 40 ms but less than 80 ms, the channel response matrix is predicted (as described above) to reduce the performance degradation caused by channel aging.

More specifically, based on the two past channel response matrices 451 and 452 obtained by channel estimation operations at time slot=0 and time slot=40 ms, the channel response matrices 453 may be predicted at time slots=41 ms, 42 ms, . . . , 79 ms. Then, at least one of an SVD or EVD operation may be performed on the predicted channel matrices at each of the time slots=41 ms, 42 ms, . . . , 79 ms, respectively. The obtained eigenvectors or singular vectors of the channel matrix can then be used to construct a beamforming matrix. Thus, precoded beamformed transmission may be possible at time slots=41 ms, 42 ms, . . . , 79 ms.

Hence, the channel prediction method as shown in the example of FIG. 4E may require at least one of an SVD or EVD operation at all time slots where channel prediction is performed, specifically at time slots=41 ms, 42 ms, . . . , 79 ms. However, an SVD or EVD operation may have high complexity. Hence, in some examples, it may be preferable to reduce the number of SVD or EVD operations.

It may be possible to reduce the number of SVD or EVD operations by directly predicting the eigenvectors of the channel response matrix at the time instants where channel prediction is desired. This is described with an example in FIG. 4F. Specifically, with reference to FIG. 4F, instead of predicting the channel response matrix at every time slot of downlink transmission, an eigenvector is directly predicted (454). Hence, the necessity of performing the complex operations of SVD or EVD at every time slots of downlink transmission where no channel estimation is performed can be avoided. Thus, SVD or EVD operation can be performed only at the time slots of channel estimation (time slot=0 and 40 ms in FIG. 4F). Then, using the eigenvectors obtained at time slot=0 and 40 ms, the eigenvectors 454 (or correspondingly, the beamforming matrices) can be directly predicted at timeslots=41 ms, 42 ms, 43 ms, 44 ms, and so on. Thus, by directly predicting the eigenvectors instead of predicting the raw channel matrix, the total number of SVD or EVD operations between two channel estimation instants can be significantly reduced, which can reduce the overall complexity of the system.

With reference to FIG. 4G, a functional configuration of a BS device 400 that includes an SRS-based channel estimator and channel predictor is described. The BS device 400 has an array antenna composed of M antennas 410_1 to 410_M, where M is an integer greater than one. The antennas 410_1 to 410_M are connected to wireless transceivers (TR) 420_1 to 420_M, respectively. Each wireless transceiver 420 includes a Radio Frequency (RF) front end 421, a fast Fourier transform (FFT) section 422, and an inverse FFT (IFFT) section 423. The RF front end 421 inputs a RF received signal from a corresponding antenna and outputs a sequence of received data to the FFT section 422. The RF front end 421 inputs a sequence of transmission data from the IFFT section 423 and outputs a RF transmission signal to the corresponding antenna. The FFT section 422 decomposes the sequence of received data to frequency components. The IFFT section 423 composes a sequence of transmission data from frequency components.

The BS device 400 further includes a channel estimator 431, a channel predictor 432 and a precoder 433. The channel estimator 431 inputs frequency components of a UL-SRS from the FFT section 422 of each radio transceiver and outputs channel estimation signals to the channel predictor 432. The channel predictor 432 predicts channel responses at time instants where no channel estimation is performed from two or more past channel responses as described before (see e.g., FIGS. 4D and 4E). The channel predictor 432 outputs the predicted channel responses to the precoder 433.

The BS device 400 further includes a scheduler 434 and a plurality of data processing sections, including a data generator 435, a forward error correction (FEC) section 436, a modulator 437 and a resource mapper 438. The scheduler 434 decides which users are scheduled for DL transmission in a given time slot. The data generator 435 generates transmission data, which is subjected to FEC at the FEC section 436. The modulator 437 modulates the output of the FEC section 436 to output modulated transmission data to the resource mapper 438. The resource mapper 438 performs resource-mapping of transmission data to output frequency components to the IFFT section 423 of each transceiver through the precoder 433. The precoder 433 performs precoding according to the estimated and/or predicted channel responses received from the channel estimator 431 and/or the channel predictor 432. As described before, the channel prediction can be done for future time slots and the predicted channel responses are stored in a memory. Or the channel prediction can be done in real time in each time slot.

The functions as denoted by reference numerals 431-438 in FIG. 4G may be implemented by one or more processors and/or one or more central processing units (CPUs) running programs stored in a program memory 440. The programs include a channel prediction program which can implement the function of the channel predictor 432. Although the functional configuration of the BS device 400 is explained in FIG. 4G using the example of an SRS as a reference signal, it may be possible to use another reference signal other than SRS, for example, a demodulation reference signal (DMRS) for channel estimation.

Furthermore, with reference to FIG. 4H, a functional configuration of a BS device 400 that includes an eigenvector predictor is described. All other functional blocks in FIG. 4H are the same as those described above in FIG. 4G. The eigenvector predictor 439 predicts the eigenvectors of the channel responses at time instants where beamforming is desired but no channel estimation is performed, from two or more past eigenvectors as described before (see e.g., FIG. 4F). The eigenvector predictor 439 outputs the predicted eigenvectors to the precoder 433.

Apart from the channel prediction and eigenvector prediction methods described here, there can be other methods of predicting at least one parameter related to the channel state information (CSI) between a base station and a UE which can be construed within the scope of the present disclosure. In some examples, a UE can predict the future CSI and send it to a base station. In some examples, the base station can predict the future CSI based on received feedback. In a time-domain CSI prediction with one-sided model, a prediction model can be implemented on the UE side only. Such a method may largely reuse existing CSI framework.

Not limited to CSI prediction, other techniques including, but not limited to, the prediction of channel quality indicator (CQI), rank indicator (RI), precoding matrix indicator (PMI), signal-to-noise-plus-interference ratio (SINR), Doppler shift, path loss, angle of arrival (AoA) and angle of departure (AoD) may also be considered. In some examples, various machine learning models can be used for artificial intelligence (AI)/ machine learning (ML) based CSI prediction. Such AI/ML models may include recurrent neural network (RNN), long short-term memory (LSTM) networks, convolutional neural networks (CNN), transformer model, multi-layer perceptron (MLP)-mixer, fully convolutional network (FCN), or auto-regression models to forecast future CSI based on past and current channel information. Furthermore, in some examples, non-AI/ML based prediction methods may be used, including at least one of a sample-and-hold method, a Wiener filter method, a Kalman filter method, a Burg method, and a Yule-Walker method.

Apart from the SRS-based channel estimation, a base station device (BS) may also perform channel estimation by using DMRS. DMRS is a type of reference signal used in communication systems such as 5G NR. DMRS can be transmitted in both uplink as well as downlink. An application of DMRS is to facilitate channel estimation at a receiver such that at least one of equalization and demodulation operations can be performed. Furthermore, the channel estimate obtained from DMRS can also be used for beamforming, such as an uplink beamforming and a downlink beamforming.

Consider an example of uplink DMRS-based channel estimation method where a BS device may receive uplink DMRS from a UE, such as during PUSCH or PUCCH transmission. Specifically, the DMRS symbols may be frequency-multiplexed with PUSCH/PUCCH data symbols. DMRS may be configured as front-loaded (pre-DMRS) and additional DMRS symbols. The BS device may then extract the uplink DMRS from a received signal (for example, a received PUSCH signal), and compare it with a known reference signal. Thus, some characteristics of the wireless channel such as fading may be estimated which entails how the signal is modified during the transmission. More specifically, the BS device can perform uplink channel estimation using the received uplink DMRS employing a channel estimation algorithm, for example at least one of a least square (LS) channel estimation algorithm, a linear minimum mean square error (MMSE) channel estimation algorithm, a discrete Fourier transform (DFT)-based channel estimation algorithm, a discrete cosine transform (DCT)-based channel estimation algorithm or some other channel estimation algorithm.

In an example, uplink DMRS symbols may be sent by frequency-multiplexing with data symbols on the resource blocks (RBs) where uplink data transmission is scheduled, for example in an uplink slot or uplink part of a special slot. In other words, such DMRS-based channel estimation may be possible only on the RBs selected by a scheduler for PUSCH transmission, on the uplink slot or the uplink part of a special slot. Hence, DMRS-based channel estimation method may have less flexibility to perform channel estimation on any arbitrary desired frequency (for example, RB) of the entire channel.

In contrast, an SRS-based channel estimation method may offer greater flexibility for sounding (and estimating) any frequency subcarrier (or for example, RB) in the entire channel. Thus, SRS-based channel estimation may not be dependent on PUSCH or PUCCH transmission scheduling, i.e., PUSCH/PUCCH transmission RBs and PUSCH/PUCCH transmission uplink slots. A BS device can configure or reconfigure the transmission of SRS from a UE on any desired RB (for example, full channel or all RBs, a specific RB group etc.) on an uplink slot or the uplink part of a special slot, allowing greater flexibility to estimate any part of the channel bandwidth. Such configuration of SRS may be done in at least one of a periodic, aperiodic, or semi-persistent manner.

SRS may be configured by using an RRC signaling. For example, a BS device can transmit SRS configuration parameters to the UE using RRC signaling. A periodic SRS can be transmitted by the UE to the BS device in a periodic manner, based on the SRS configuration parameters. An aperiodic SRS can be dynamically triggered by the BS using downlink control information (DCI) or other signaling methods. Furthermore, a semi-persistent SRS may be transmitted in a periodic manner similar to periodic SRS, but it can be dynamically activated or deactivated by using medium access control (MAC) control elements (CEs) or other signaling methods. The configurable parameters of SRS that a BS device may determine for each UE can include at least one of the number of SRS ports, time-domain position, frequency-domain position, bandwidth, cyclic shift, transmission comb and offset etc.

In one or more of the examples described above, the longer the time between the timing of the channel estimation (based on SRS or uplink DMRS) and the (uplink or downlink) beamforming, the worse may be the quality of channel estimate, due to the effect of channel aging. More specifically, if an outdated channel estimate value obtained from received SRS or uplink DMRS is used for calculating uplink or downlink beamforming weight, then the quality of signal transmission or reception may be degraded. This is because accurate channel state information (CSI) is crucial for effective beamforming and/or precoding in massive MIMO systems, for example in 5G and beyond communications. As explained earlier, an effective approach to solve the problem of channel aging may be channel prediction or eigenvector prediction.

In examples where uplink DMRS-based channel estimate is used for uplink data symbol equalization and demodulation, such as for demodulating the data symbols that were transmitted in the same time slot as the DMRS symbols, there may not be an effect of channel aging since data symbols and DMRS symbols are received in the same time slot. However, there can be examples of applications in which DMRS-based channel estimates may benefit from channel prediction or eigenvector prediction. For example, if a DMRS-based channel estimate is used at a later time slot (i.e., in a time slot later than the time where uplink DMRS was received), such as for downlink beamforming at a later slot, then channel aging may affect the channel estimate, necessitating operations like channel prediction or eigenvector prediction for the mitigation of channel aging.

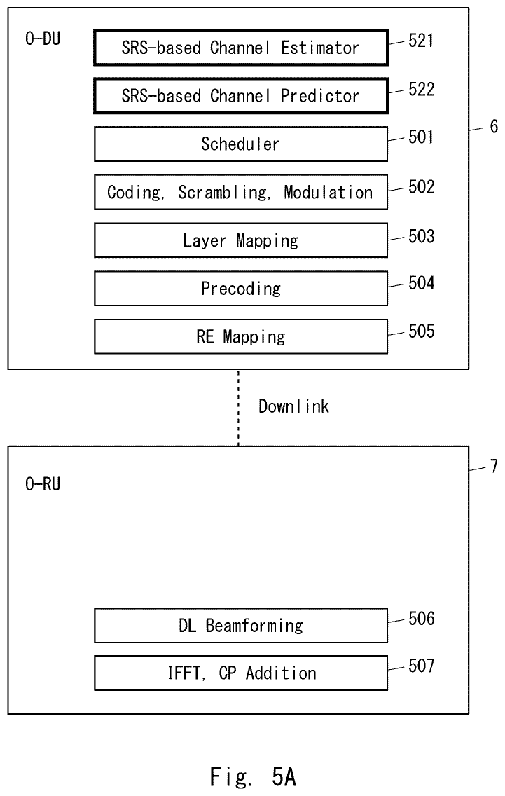

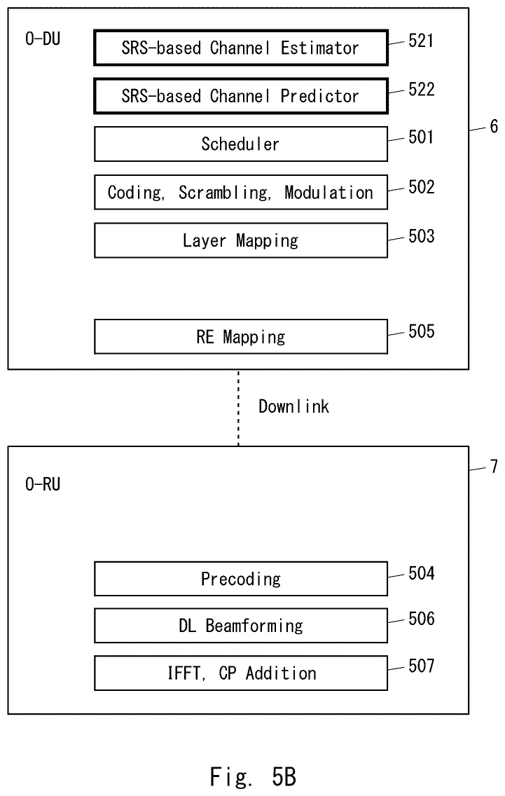

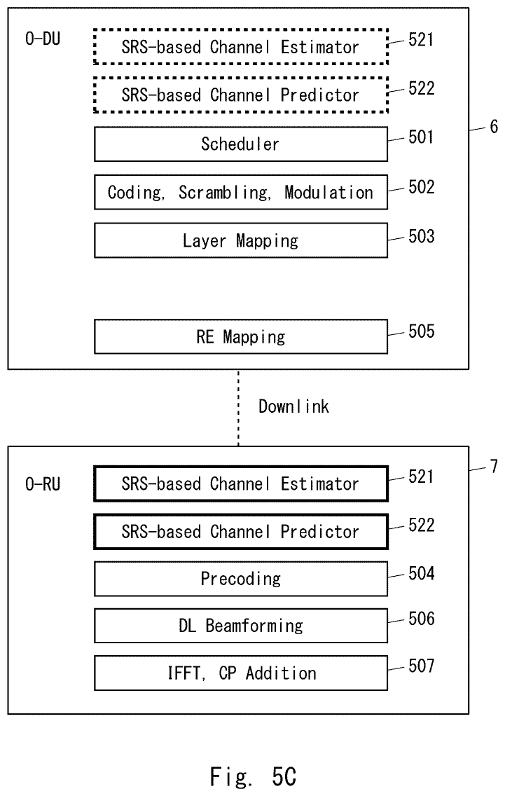

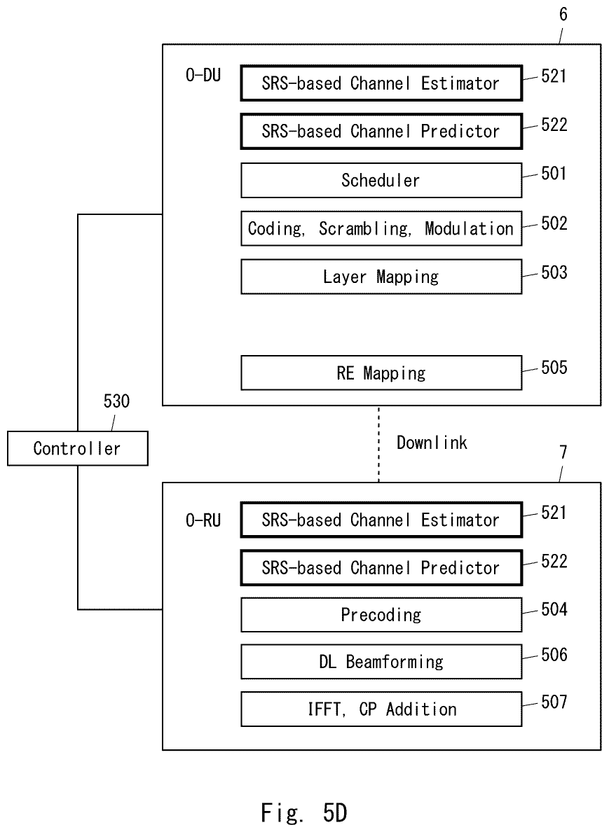

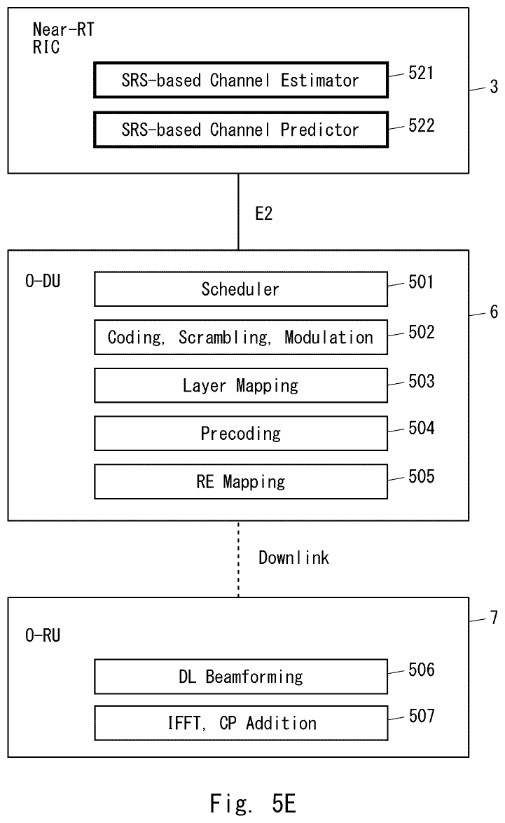

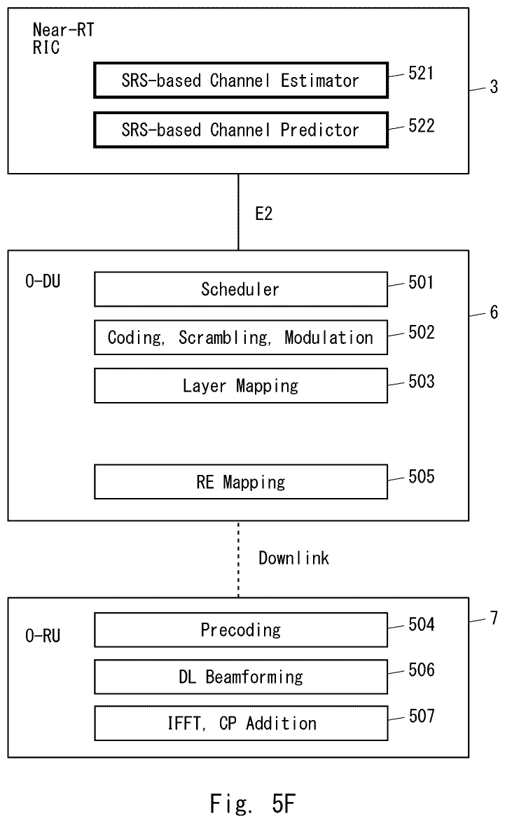

Specific examples of the placement of SRS-based channel estimation and SRS-based channel prediction are shown below with reference to FIGS. 5A-5F. FIGS. 5A-5F illustrate the arrangement of processing blocks related to downlink transmission (e.g., PDSCH transmission) by a base station.

As mentioned above, according to the current O-RAN technical specifications, SRS-based channel estimation is placed in the O-DU (see, for example, Non-Patent Literature 1,section 4.2). Accordingly, in this case, SRS-based channel prediction 522 may be placed in the O-DU 6 together with SRS-based channel estimation 521, as shown in FIG. 5A or FIG. 5B.

FIG. 5A shows a configuration of the Category A O-RU, where precoding 504 is placed in the O-DU 6. In the example in FIG. 5A, the O-DU 6 includes scheduler 501, coding, scrambling and modulation 502, layer mapping 503, precoding 504, and RE mapping 505. The O-DU 6 also includes SRS-based channel estimation 521 and SRS-based channel prediction 522. The O-RU 7 includes DL beamforming 506 and IFFT and CP addition 507. Placing the SRS-based channel estimation 521, the SRS-based channel prediction 522, and the precoding 504 in the same logical unit, i.e., the O-DU 6, helps to reduce the control loop latency required to compute the precoding weights. This can contribute to improved performance, particularly in environments with many high-mobility UEs.

On the other hand, FIG. 5B shows an example of the Category B O-RU, where the precoding 504 is placed in the O-RU 7. In the example in FIG. 5B, the O-DU 6 includes the scheduler 501, the coding, scrambling and modulation 502, the layer mapping 503, and the RE mapping 505. The O-DU 6 also includes the SRS-based channel estimation 521 and the SRS-based channel prediction 522. The O-RU 7 includes the precoding 504, the DL beamforming 506, and the IFFT and CP addition 507.

Instead of the arrangement shown in FIGS. 5A and 5B, the arrangement shown in FIG. 5C may be used. In the example of FIG. 5C, the SRS-based channel prediction 522 is placed in the O-RU 7 together with the SRS-based channel estimation 521. Further, in the example of FIG. 5C, the precoding 504 is placed in the O-RU 7. As mentioned above, SRS-based beamforming, i.e., the calculation of downlink precoding weights or beamforming weights using the results of SRS-based channel estimation, requires SRS-based channel prediction to improve performance. Placing the SRS-based channel estimation 521, the SRS-based channel prediction 522, and the precoding 504 in the O-RU 7 helps reduce the control loop latency required to compute the precoding weights. This can contribute to improved performance, particularly in environments with many high-mobility UEs. In addition, the arrangement in FIG. 5C has the advantage of reduced fronthaul capacity compared to the arrangement in FIG. 5A because the precoding 504 is located in the O-RU 7.

Note that in the example of FIG. 5C, the O-DU 6 may also have the SRS-based channel estimation 521 and the SRS-based channel prediction 522, as indicated by the dotted lines in FIG. 5C. The results of the SRS-based channel estimation 521 and/or the results of the SRS-based channel prediction 522 placed in the O-DU 6 may be used for link adaptation and scheduling for the uplink. Additionally or alternatively, they may be used for link adaptation and scheduling for the downlink.

In an example, the SRS-based channel estimation and SRS-based channel prediction may be placed in both the O-RU 7 and the O-DU 6, and can be optionally enabled in one of the O-RU 7 and the O-DU 6. Such optional (or conditional) enabling of SRS-based channel estimation and SRS-based channel prediction in one of the O-RU 7 and the O-DU 6 may be determined based on one or more conditions or criteria. In an example, the one or more conditions may be based on or related to one or any combination of OFH traffic, latency, capacity, etc. The decision to enable SRS-based channel estimation and SRS-based channel prediction in either the O-RU 7 or the O-DU6 can be based on a comparison of one or more parameters, such as OFH traffic, latency and capacity, with one or more thresholds. More specifically, if at least one of the OFH traffic, latency, and capacity is less or greater than a threshold, then the SRS-based channel estimation and SRS-based channel prediction may be enabled in the O-RU 7. Otherwise, the SRS-based channel estimation and SRS-based channel prediction may be enabled in the O-DU6. Other conditions to determine the enabling/disabling of at least one of SRS-based channel estimation and SRS-based channel prediction in the O-RU 7 can be considered within the scope of the present disclosure. In an example, there can be a controller (e.g., the Near-RT RIC 3 or the Non-RT RIC 2) to perform the decision of whether to enable the channel estimation and channel prediction functions in the O-DU 6 or O-RU 7 based on at least one predetermined condition. FIG. 5D illustrates a controller 530 that is an example of the controller described above.

Instead of the arrangement shown in FIGS. 5A to 5D, the arrangement shown in FIG. 5E or 5F may be used. In the examples of FIGS. 5E and 5F, the SRS-based channel estimation 521 and the SRS-based channel prediction 522 are placed in the Near-RT RIC 3. The difference between FIG. 5E and FIG. 5F is that in FIG. 5E, the precoding 504 is placed in the O-DU 6, while in FIG. 5F, the precoding 504 is placed in the O-RU 7. In the arrangements shown in FIGS. 5E and 5F, the signaling between the SRS-based channel estimation 521 and the SRS-based channel prediction 522 takes place within the Near-RT RIC 3. Accordingly, these arrangements may help to somewhat suppress traffic growth at an interface between logical units. However, given the need to calculate precoding weights using the results of the SRS-based channel prediction 522, the benefits of reduced control latency and the benefits of reduced control traffic at an interface between logical units obtained by the arrangement of FIG. 5C or FIG. 5A would be more significant.

### Second Example Embodiment

An example configuration of a radio communication system according to this example embodiment is similar to the configuration described with reference to FIG. 1-3. This example embodiment provides details on the placement of the dynamic uplink SRS resource allocation processing block, and the signaling between the dynamic uplink SRS resource allocation processing block and the scheduling processing block in the functional split of a base station. The scheduling processing block can be responsible for allocating resources (for example, RBs) to each UE, for at least one of an uplink transmission and a downlink transmission. In other words, the scheduling processing block includes one or both of uplink scheduling processing block (or scheduler) and downlink scheduling processing block (or scheduler).

The dynamic uplink SRS resource allocation processing block dynamically determines uplink SRS resources (e.g., period, frequencies, REs, RBs, hopping, etc.) to be allocated to a UE. Increasing the amount of SRS resources allocated to a UE helps reduce performance degradation due to channel aging, but also increases communication overhead. Therefore, the dynamic uplink SRS resource allocation processing block adaptively determines the uplink SRS resources to be allocated to a UE based on the channel state (or condition) of that UE.

The dynamic uplink SRS resource allocation processing block may use the results of either or both of the channel estimation and the channel prediction. Accordingly, the dynamic uplink SRS resource allocation processing block may be located in the same logical unit (e.g., O-DU 6 or O-RU 7) as either or both of the channel estimation processing block and the channel prediction processing block.

For example, the channel estimation and the channel prediction may be SRS-based channel estimation and channel prediction, or uplink DMRS-based channel estimation and channel prediction, to determine the channel state (or condition) of each UE so that the uplink SRS resource allocation can be done based on that channel state (or condition). Thus, in an example, the dynamic uplink SRS resource allocation processing block may be located in the same logical unit (e.g., O-DU 6 or O-RU 7) as either or both of the SRS-based channel estimation processing block and the SRS-based channel prediction processing block. Further or alternatively, the dynamic uplink SRS resource allocation processing block may be located in the same logical unit (e.g., O-DU 6 or O-RU 7) as either or both of the uplink DMRS-based channel estimation processing block and the uplink DMRS-based channel prediction processing block.

This can reduce traffic growth at an interface between different logical units (e.g., OFH C-plane) in cases where the dynamic uplink SRS resource allocation processing block is introduced in a base station system (e.g., gNB). In some examples, the dynamic uplink SRS resource allocation processing block may obtain information about a UE's condition from the channel estimation block at periodic or aperiodic intervals, and dynamically modify the uplink SRS resource allocation based on the received information.

Additionally or alternatively, the dynamic uplink SRS resource allocation processing block may be located in the same logical unit (e.g., O-DU 6) as the uplink and/or downlink scheduling processing block. This arrangement facilitates the use of the results of the dynamic uplink SRS resource allocation for one or both of uplink scheduling and downlink scheduling. For example, the downlink scheduler may allocate at least one of PDCCH transmission resources and PDSCH transmission resources for a UE around (for e.g., adjacent to) the SRS resources allocated to that UE. More specifically, in one example, an RB where SRS is most recently received in the uplink from a UE may have the most accurate CSI. Hence, if the information about dynamic uplink SRS resource allocation is shared with the uplink and/or downlink scheduling processing block, then the uplink and/or downlink scheduling processing block may allocate such an RB in a subsequent uplink (or downlink) time slot to an imminent uplink (or downlink) signal transmission. For example, the PDSCH transmission to a UE can be scheduled in a downlink time slot soon after receiving the SRS, on the same RB where SRS was received. Similarly, a PUSCH transmission can be scheduled from a UE in an uplink time slot soon after receiving the SRS, on the same RB where SRS was received. This may contribute to improved performance of PDSCH and/or PUSCH transmission, as the downlink beamforming and/or uplink beamforming takes into account the channel state estimated or predicted from the recent SRS reception results.

Alternatively, this arrangement facilitates the use of the uplink and/or downlink scheduling results for dynamic uplink SRS resource allocation. For example, the dynamic uplink SRS resource allocation processing block may allocate uplink SRS transmission resources for a UE around (for e.g., just before) the PDSCH resources allocated to that UE, which may result in improved performance of PDSCH transmission. Similarly, the dynamic uplink SRS resource allocation processing block may allocate uplink SRS transmission resources for a UE around (for e.g., just before) the PUSCH resources allocated to that UE, which may result in improved performance of PUSCH transmission.

More specifically, in one example of downlink, the dynamic uplink SRS resource allocation processing block may obtain information about PDSCH scheduling to a particular UE from the downlink scheduler. Then, based on this information about PDSCH scheduling for a UE, the dynamic uplink SRS resource allocation processing block can determine the allocation of SRS resources for that UE. That means, the RBs and/or time slots where SRS transmission from that UE should be scheduled is decided based on its imminent PDSCH schedule. Such a method would ensure that accurate CSI is obtained on the RBs where downlink signal transmission is desired. Additionally, such a method may also prevent unnecessary channel estimation on the RBs where no downlink signal transmission is scheduled, thus reducing pilot (reference signal) overhead and creating opportunities for data transmission.

Note that, in the examples described here, only some typical scenarios of performance improvement based on information exchanged between an uplink and/or downlink scheduler and a dynamic uplink SRS resource allocation processing block have been explained. However, all possible scenarios where an uplink and/or downlink scheduler and a dynamic uplink SRS resource allocation processing block may exchange information with each other (in either or both directions) for the improvement of at least one performance metric in communication system should be construed within the scope of the present disclosure.

In the present disclosure, a scheduler which is responsible for at least one of an uplink scheduling and downlink scheduling (for example, PUSCH scheduling, PUCCH scheduling, PDSCH scheduling, or PDCCH scheduling) can exchange information with a dynamic uplink SRS resource allocation processing block. In an example of 5G NR system, downlink scheduling may be performed by at least one of dynamic scheduling and a semi-persistent scheduling. Similarly, an uplink scheduling may be performed by at least one of a dynamic scheduling and a semi-persistent scheduling. Semi-persistent scheduling can be referred to as configured scheduling or configured grant operation, especially for the uplink.

More specifically, in dynamic downlink scheduling, a PDSCH scheduling may be performed by using PDCCH, for example, the BS (e.g., gNB) may notify the UE about PDSCH scheduling and grant using DCI (such as DCI 1_0 or DCI 1_1). In an example, the PDSCH transmission may be performed K0 slots after the PDSCH grant. Using such dynamic scheduling with DCI can allow the BS to change the scheduling parameters for every transmission, for example to adapt to the radio link condition. In a downlink semi-persistent scheduling, the PDSCH transmission may be scheduled by using RRC signaling. Thus, based on information exchanged between the dynamic uplink SRS resource allocation processing block and the downlink scheduler, the BS may determine the PDSCH resource allocation and notify a UE using at least one of a DCI, RRC signaling, or other signaling methods.

In dynamic uplink scheduling, each PUSCH transmission may be scheduled by using DCI (such as DCI 0_0 or DCI 0_1). In an uplink semi-persistent scheduling, the PUSCH transmission may be scheduled by using RRC signaling instead of using DCI for every PUSCH transmission, which can reduce the load of PHY/MAC scheduling process. Thus, based on information exchanged between the dynamic uplink SRS resource allocation processing block and the uplink scheduler, the BS may determine the PUSCH resource allocation and notify a UE using at least one of a DCI, RRC signaling, or other signaling methods.

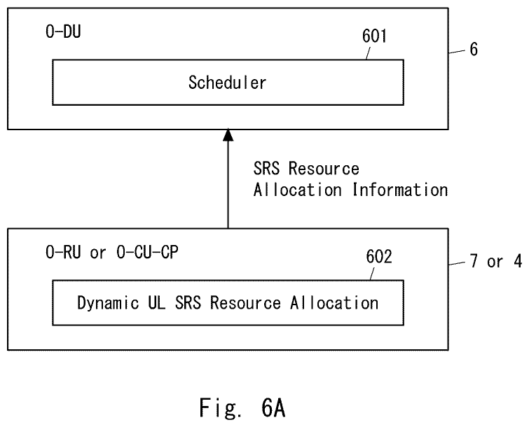

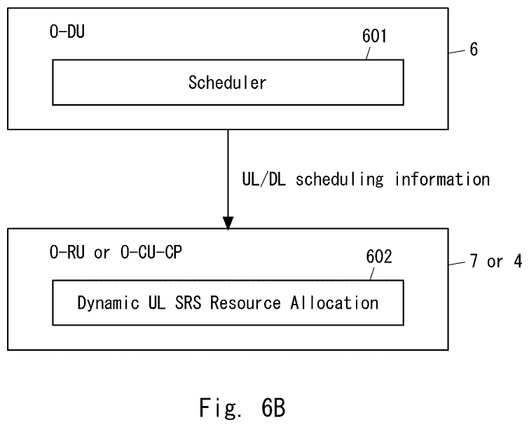

As will be appreciated from the above description, in some implementations, the dynamic uplink SRS resource allocation processing block may be placed in a different logical block than the uplink/downlink scheduling processing block. FIGS. 6A and 6B show examples of the placement of the dynamic uplink SRS resource allocation processing block and the signaling between the dynamic uplink SRS resource allocation processing block and the scheduling processing block. In FIGS. 6A and 6B, the scheduler 601 is located in the O-DU 6, while the dynamic uplink SRS resource allocation 602 is located in the O-RU 7 or the O-CU-CP 4.

The scheduler 601 performs one or both of uplink scheduling and downlink scheduling for one or more UEs as described above. The dynamic uplink SRS resource allocation 602 dynamically determines the uplink SRS resources (e.g., period, frequency, REs, RBs, hopping, etc.) to be allocated to a UE. The dynamic uplink SRS resource allocation 602 adaptively determines the uplink SRS resources to be allocated to a UE based on the channel state (or condition) of that UE.

In the example of FIG. 6A, the dynamic uplink SRS resource allocation 602 sends information indicating the dynamically determined uplink SRS resource allocation for a UE to the scheduler 601. The scheduler 601 receives this information from the dynamic uplink SRS resource allocation 602. The scheduler 601 may use the received information to determine the uplink resources (e.g., PUSCH resources) and/or downlink resources (e.g., PDSCH resources) to be allocated to that UE.

The scheduler 601 or the O-DU 6 (e.g., OFH C-plane termination) may request the O-RU 7 or the O-CU-CP 4 to send information indicating uplink SRS resource allocation. The dynamic uplink SRS resource allocation 602 may send information indicating uplink SRS resource allocation in response to a request from the scheduler 601 or the O-DU 6 (e.g., OFH C-plane termination). Additionally or alternatively, the dynamic uplink SRS resource allocation 602 may autonomously send information indicating uplink SRS resource allocation to the scheduler 601 or the O-DU 6 (e.g., OFH C-plane termination) in response to an update of the uplink SRS resource allocation.

The dynamic uplink SRS resource allocation 602 may send information indicating uplink SRS resource allocation via a control plane message in the fronthaul interface (e.g., OFH, LLS) to the scheduler 601 or the O-DU 6 (e.g., OFH C-plane termination). The format of this control message may be the same as one of the existing formats or it may be a newly defined format.

In the example of FIG. 6B, the scheduler 601 sends information indicating one or both of an uplink resource allocation and a downlink resource allocation for a UE to the dynamic uplink SRS resource allocation 602. This information may indicate one or both of a dynamic uplink resource allocation and a dynamic downlink resource allocation to the UE, or one or both of a semi-persistent (or configured) uplink resource allocation and a semi-persistent (or configured) downlink resource allocation to the UE. The dynamic uplink SRS resource allocation 602 receives this information from the scheduler 601. The dynamic uplink SRS resource allocation 602 may use the received information to determine the uplink SRS resource allocation to that UE.

The scheduler 601 may send information indicating one or both of a dynamic uplink resource allocation and a downlink resource allocation via a control plane message in the fronthaul interface (e.g., OFH, LLS) to the dynamic uplink SRS resource allocation 602 or the O-RU 7 (e.g., OFH C-plane termination). The format of this control message may be the same as one of the existing formats or it may be a newly defined format.

The transmission of information indicating uplink SRS resource allocation described with reference to FIG. 6A and the transmission of information indicating uplink and/or downlink resource allocation described with reference to FIG. 6B may be performed in combination.

### Third Example Embodiment

An example configuration of a radio communication system according to this example embodiment is similar to the configuration described with reference to FIGS. 1-3. This example embodiment provides details on the information exchange between O-DU and O-RU for one or more purposes described in this disclosure, including the first and second example embodiments.

In one example, the information exchange between the O-DU 6 and the O-RU 7 for one or more of the purposes described in this disclosure can be implemented by using “Section Extension”. In another example, a new message format may be used, such as a new Control Plane (C-Plane) message.

A “Section” in the O-RAN context may be a fundamental unit that defines one or more characteristics of data which may be transmitted or received, for example in the context of User Plane (U-Plane) or C-plane. Thus, Sections can be used to structure and organize data transmission between the O-DU 6 and the O-RU 7. A typical Section may contain information or fields such as Section type, Section ID, time reference, beam information, resource block information, I-Q data (for U-Plane), and control information (for C-Plane). A C-Plane may have 6 Section types: Section Type 0, 1, 3, 5, 6, 7. A U-Plane may have 4 Section types: Section Type 1, 3, 5, 6. By using a Section Extension, additional data beyond the standard Section fields may be included, which can provide extensibility and greater flexibility in the data structure to support additional functionalities.

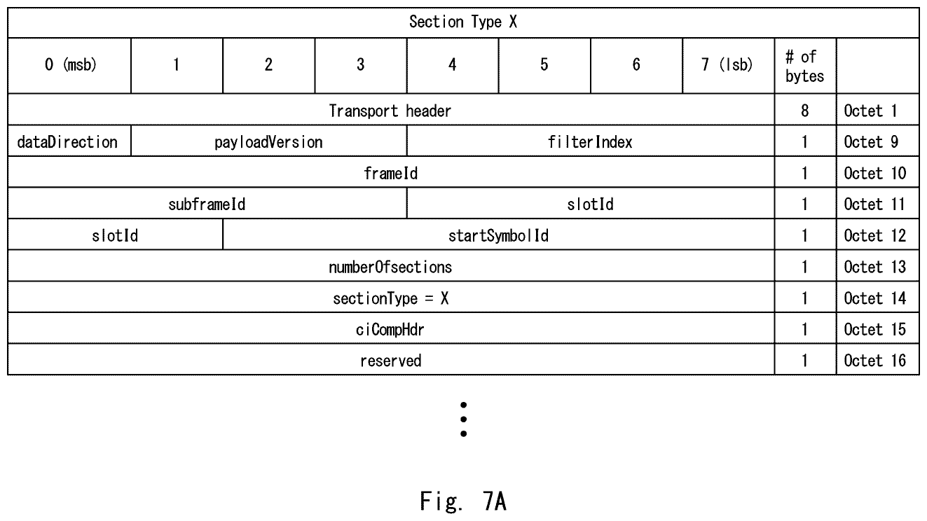

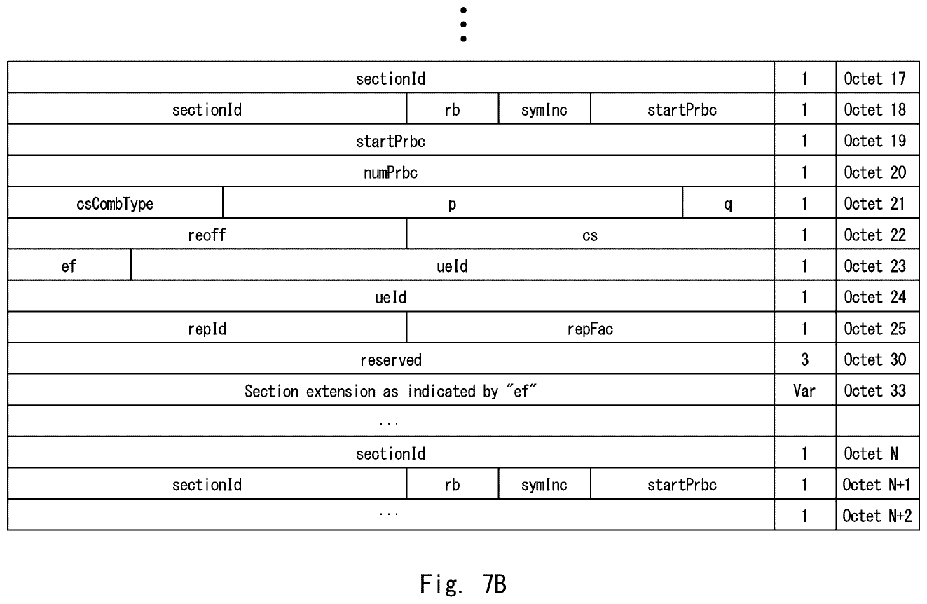

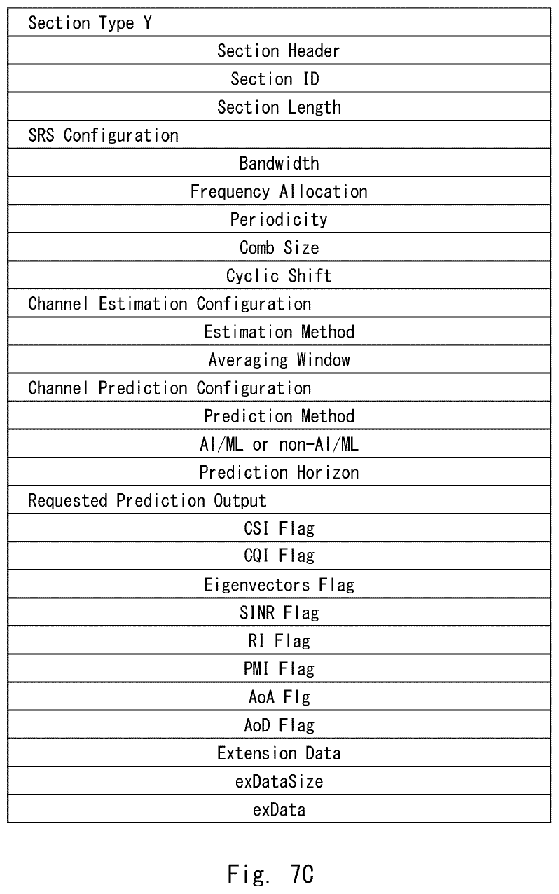

In an example, an architecture proposed in FIG. 5C can be implemented using the new C-Plane message shown in FIGS. 7A and 7B. More specifically, for an example where the SRS-based channel estimation and channel prediction units can be enabled in the O-RU7, specific instructions can be sent from the O-DU 6 to the O-RU 7 using such a C-plane message. The new Section Type X is used to deliver SRS-related information from the O-DU 6 to the O-RU 7.

Here, “X” indicates a generic placeholder for the new Section. The new Section may specify SRS setup information such as sequence group number (p), sequence number (q), cyclic shift (cs), resource element (RE) level offset (reoff), transmission comb type (ct), repetition index (repId), and repetition factor (repFac).

Furthermore, FIG. 7C shows another example of message, which can be used either in combination with FIGS. 7A and 7B, or separately. For example, as shown in FIG. 7C, SRS configuration parameters such as bandwidth, frequency allocation, periodicity, comb size, cyclic shift, etc. are specified. Then, a channel estimation configuration may be specified, such as an estimation method, an averaging window, etc. The channel estimation configuration may include channel estimation granularity in frequency domain. The channel estimation configuration may include a type of the averaging window and a size of the averaging window. Then, a channel prediction configuration may be specified, such as prediction method, AI/ML or non-AI/ML, prediction horizon, etc. The prediction method may be specified from a predefined list of prediction methods. Then, a requested prediction output may be specified, such as CSI flag, CQI flag, eigenvectors flag, SINR flag, RI flag, PMI flag, AoA flag, AoD flag, etc.

FIGS. 7A to 7C are simple examples to implement C-Plane message exchange in one example embodiment of the present disclosure. However, there can be many different ways of implementing the C-Plane message exchange, for example, using the Section Extension as mentioned before. For example, in another example, at least one of ‘exDataSize’ and ‘exData’ fields of the O-RAN library may be used for the information exchange between the O-DU 6 and the O-RU 7 for one or more of the purposes described in this disclosure.

The above-described example embodiments are merely examples of applications of the technical ideas obtained by the inventor. These technical ideas are not limited to the above-described example embodiments and various modifications can be made thereto.

For example, the whole or part of the example embodiments disclosed above can be described as, but not limited to, the following supplementary notes. Of course, some or all of the elements (e.g., configurations and functionalities) described in the Supplementary Notes directed to an apparatus may also be described as or in Supplementary Notes directed to methods and programs. For example, some or all of the elements listed in Supplementary Notes 15-24 that depend on Supplementary Note 14 may also be listed as Supplementary Notes that depend on Supplementary Note 25 with the same dependency as Supplementary Notes 15-24. As another example, some or all of the elements listed in Supplementary Notes 35-41 that depend on Supplementary Note 34 may also be listed as Supplementary Notes that depend on Supplementary Note 42 or 43 with the same dependency as Supplementary Notes 35-41. Some or all of the elements described in a Supplementary Note may be applicable to various hardware, software, storage for storing software, systems, and methods.

### (Supplementary Note 1)

### A Base Station System Comprising:

a Radio Unit (RU) configured to perform low physical layer signal processing;
a Distributed Unit (DU) configured to perform high physical layer signal processing; and
a controller configured to perform near-real-time control of radio access network elements and resources, including at least the DU, wherein
the at least one of the RU, the DU, and the controller is configured to perform both channel estimation and channel prediction.

### (Supplementary Note 2)

The base station system according to Supplementary Note 1, wherein the one configured to perform the channel estimation and the channel prediction is the RU.

### (Supplementary Note 3)

The base station system according to Supplementary Note 2, wherein the RU is further configured to perform precoding for downlink transmission.

### (Supplementary Note 4)

The base station system according to Supplementary Note 3, wherein the RU is configured to perform the precoding using a result of the channel prediction.

### (Supplementary Note 5)

The base station system according to any one of Supplementary Notes 1 to 4, wherein
the RU is an O-RAN Radio Unit conforming to Open Radio Access Network (O-RAN) technical specifications,
the DU is an O-RAN Distributed Unit conforming to the O-RAN technical specifications, and
the controller is a Near-Real-Time RAN Intelligent Controller conforming to the O-RAN technical specifications.

### (Supplementary Note 6)

The base station system according to any one of Supplementary Notes 1 to 5, wherein
the channel estimation comprises estimating channel characteristics between a User Equipment (UE) and the RU using a result of reception of at least one of a Sounding Reference Signal (SRS) and an uplink Demodulation Reference Signal (DMRS) transmitted by the UE, and
the channel prediction comprises a temporal prediction, using a result of the channel estimation, of the channel characteristics, eigenvectors for downlink transmission to the UE, precoding weights for the downlink transmission, beamforming weights for the downlink transmission, or downlink beams for the downlink transmission.

### (Supplementary Note 7)

The base station system according to any one of Supplementary Notes 1 to 6, wherein the DU is configured to perform scheduling of one or both of uplink resources and downlink resources, and to perform dynamic uplink Sounding Reference Signal (SRS) resource allocation.

### (Supplementary Note 8)

The base station system according to any one of Supplementary Notes 1 to 6, wherein the DU is configured to perform scheduling of one or both of uplink resources and downlink resources and to receive information from the RU or a Central Unit (CU) indicating an uplink Sounding Reference Signal (SRS) resource allocation dynamically determined by the RU or the CU.

### (Supplementary Note 9)

The base station system according to Supplementary Note 8, wherein the DU is configured to request the RU or the CU to send the information indicating the uplink SRS resource allocation.

### (Supplementary Note 10)

The base station system according to Supplementary Note 8, wherein the RU is configured to autonomously send the information indicating the uplink SRS resource allocation to the DU in response to an update of the uplink SRS resource allocation.

### (Supplementary Note 11)

The base station system according to any one of Supplementary Notes 8 to 10, wherein the DU is configured to receive the information indicating the uplink SRS resource allocation from the RU via a control plane message in a fronthaul interface between the DU and the RU.

### (Supplementary Note 12)

The base station system according to any one of Supplementary Notes 1 to 6, wherein the DU is configured to perform scheduling of one or both of uplink resources and downlink resources and to send information indicating a resource allocation for a User Equipment (UE) to the RU or a Central Unit (CU), which performs dynamic uplink Sounding Reference Signal (SRS) resource allocation.

### (Supplementary Note 13)

The base station system according to Supplementary Note 12, wherein the DU is configured to send the information indicating the resource allocation to the RU via a control plane message in a fronthaul interface between the DU and the RU.

### (Supplementary Note 14)

A Radio Unit (RU) comprising:
means for performing low physical layer signal processing;
means for communicating via a fronthaul interface with a Distributed Unit (DU) configured to perform high physical layer signal processing; and
means for performing channel estimation and channel prediction.

### (Supplementary Note 15)

The RU according to Supplementary Note 14, further comprising means for performing precoding for downlink transmission.

### (Supplementary Note 16)

The RU according to Supplementary Note 15, wherein the means for performing the precoding is configured to perform the precoding using a result of the channel prediction.

### (Supplementary Note 17)

The RU according to any one of Supplementary Notes 14 to 16, wherein
the RU is an O-RAN Radio Unit conforming to Open Radio Access Network (O-RAN) technical specifications, and
the DU is an O-RAN Distributed Unit conforming to the O-RAN technical specifications.

### (Supplementary Note 18)

The RU according to any one of Supplementary Notes 14 to 17, wherein
the channel estimation comprises estimating channel characteristics between a User Equipment (UE) and the RU using a result of reception of at least one of a Sounding Reference Signal (SRS) and an uplink Demodulation Reference Signal (DMRS) transmitted by the UE, and
the channel prediction comprises a temporal prediction, using a result of the channel estimation, of the channel characteristics, eigenvectors for downlink transmission to the UE, precoding weights for the downlink transmission, beamforming weights for the downlink transmission, or downlink beams for the downlink transmission.

### (Supplementary Note 19)

The RU according to any one of Supplementary Notes 14 to 18, further comprising means for performing dynamic allocation of uplink Sounding Reference Signal (SRS) resources.

### (Supplementary Note 20)

The RU according to Supplementary Note 19, wherein the means for communicating is configured to send information indicating dynamically determined uplink SRS resource allocation via the fronthaul interface to the DU configured to perform scheduling of one or both of uplink resources and downlink resources.

### (Supplementary Note 21)

The RU according to Supplementary Note 20, wherein the means for communicating is configured to send the information indicating the uplink SRS resource allocation to the DU in response to receiving a request from the DU.

### (Supplementary Note 22)

The RU according to Supplementary Note 20, wherein the means for communicating is configured to autonomously send the information indicating the uplink SRS resource allocation to the DU in response to an update of the uplink SRS resource allocation.

### (Supplementary Note 23)

The RU according to any one of Supplementary Notes 19 to 22, wherein the means for communicating is configured to receive information indicating a resource allocation for a User Equipment (UE) from the DU via the fronthaul interface.

### (Supplementary Note 24)

The RU according to Supplementary Note 23, wherein the means for performing dynamic allocation of uplink SRS resources is configured to allocate uplink SRS resources to the UE using the information indicating the resource allocation.

### (Supplementary Note 25)

A method performed by a Radio Unit (RU), the method comprising:
performing low physical layer signal processing;
communicating via a fronthaul interface with a Distributed Unit (DU) configured to perform high physical layer signal processing; and performing channel estimation and channel prediction.

### (Supplementary Note 26)

A method comprising:
manufacturing at least one of a Radio Unit (RU), a Distributed Unit (DU), and a controller to perform both channel estimation and channel prediction.

### (Supplementary Note 27)

The method according to Supplementary Note 26, wherein
the RU is configured to perform low physical layer signal processing,
the DU is configured to perform high physical layer signal processing; and
the controller is configured to perform near-real-time control of radio access network elements and resources, including at least the DU.

### (Supplementary Note 28)

The method according to Supplementary Note 26 or 27, wherein the manufacturing comprises manufacturing the RU such that the RU performs the channel estimation and the channel prediction.

### (Supplementary Note 29)

The method according to Supplementary Note 28, wherein the RU is further configured to perform precoding for downlink transmission.

### (Supplementary Note 30)

The method according to Supplementary Note 29, wherein the RU is configured to perform the precoding using a result of the channel prediction.

### (Supplementary Note 31)

The method according to any one of Supplementary Notes 28 to 30, further comprising manufacturing the RU such that the RU performs dynamic allocation of uplink Sounding Reference Signal (SRS) sources.

### (Supplementary Note 32)

The method according to any one of Supplementary Notes 26 to 31, wherein
the RU is an O-RAN Radio Unit conforming to Open Radio Access Network (O-RAN) technical specifications,
the DU is an O-RAN Distributed Unit conforming to the O-RAN technical specifications, and
the controller is a Near-Real-Time RAN Intelligent Controller conforming to the O-RAN technical specifications.

### (Supplementary Note 33)

The method according to any one of Supplementary Notes 26 to 32, wherein
the channel estimation comprises estimating channel characteristics between a User Equipment (UE) and the RU using a result of reception of at least one of a Sounding Reference Signal (SRS) and an uplink Demodulation Reference Signal (DMRS) transmitted by the UE, and
the channel prediction comprises a temporal prediction, using a result of the channel estimation, of the channel characteristics, eigenvectors for downlink transmission to the UE, precoding weights for the downlink transmission, beamforming weights for the downlink transmission, or downlink beams for the downlink transmission.

### (Supplementary Note 34)

A distributed unit (DU) comprising:
means for communicating via a fronthaul interface with a Radio Unit (RU) configured to perform low physical layer signal processing;
means for performing high physical layer signal processing;
means for performing at least one of uplink scheduling and downlink scheduling; and
means for receiving information indicating a dynamically determined uplink Sounding Reference Signal (SRS) resource allocation for a User Equipment (UE) from the RU or a Central Unit (CU) configured to perform dynamic uplink SRS resource allocation.

### (Supplementary Note 35)

The DU according to Supplementary Note 34, further comprising means for requesting the RU or the CU to send the information indicating the uplink SRS resource allocation.

### (Supplementary Note 36)

The DU according to Supplementary Note 34 or 35, wherein the means for receiving is configured to receive the information indicating the uplink SRS resource allocation from the RU via a control plane message in the fronthaul interface.

### (Supplementary Note 37)

The DU according to any one of Supplementary Notes 34 to 36, wherein the means for performing at least one of the uplink scheduling and the downlink scheduling is configured to determine one or both of uplink resources and downlink resources to be allocated to the UE using the information indicating the uplink SRS resource allocation.

### (Supplementary Note 38)

The DU according to any one of Supplementary Notes 34 to 37, further comprising means for sending information indicating a resource allocation for the UE to the RU or the CU configured to perform the dynamic uplink SRS resource allocation.

### (Supplementary Note 39)

The DU according to Supplementary Note 38, wherein the means for sending is configured to send the information indicating the resource allocation to the RU via a control plane message in the fronthaul interface.

### (Supplementary Note 40)

The DU according to Supplementary Note 38 or 39, wherein the information indicating the resource allocation is used by the RU or the CU to determine uplink SRS resources to be allocated to the UE.

### (Supplementary Note 41)

The DU according to any one of Supplementary Notes 34 to 40, wherein
the RU is an O-RAN Radio Unit conforming to Open Radio Access Network (O-RAN) technical specifications,
the DU is an O-RAN Distributed Unit conforming to the O-RAN technical specifications, and
the CU is an O-RAN Central Unit conforming to the O-RAN technical specifications.

### (Supplementary Note 42)

A method performed by a Distributed Unit (DU), the method comprising:
communicating via a fronthaul interface with a Radio Unit (RU) configured to perform low physical layer signal processing;
performing high physical layer signal processing;
performing at least one of uplink scheduling and downlink scheduling; and
receiving information indicating a dynamically determined uplink Sounding Reference Signal (SRS) resource allocation for a User Equipment (UE) from the RU or a Central Unit (CU) configured to perform dynamic uplink SRS resource allocation.

### (Supplementary Note 43)

A program for causing a computer to perform a method for a Distributed Unit (DU), the method comprising:
communicating via a fronthaul interface with a Radio Unit (RU) configured to perform low physical layer signal processing;
performing high physical layer signal processing;
performing at least one of uplink scheduling and downlink scheduling; and
receiving information indicating a dynamically determined uplink Sounding Reference Signal (SRS) resource allocation for a User Equipment (UE) from the RU or a Central Unit (CU) configured to perform dynamic uplink SRS resource allocation.

### (Supplementary Note 44)

A Radio Unit (RU) comprising:
means for performing low physical layer signal processing;
means for communicating via a fronthaul interface with a Distributed Unit (DU) configured to perform high physical layer signal processing;
means for dynamically allocating uplink Sounding Reference Signal (SRS) resources to a User Equipment (UE); and
means for sending information indicating an uplink SRS resource allocation for the UE to the DU configured to perform at least one of uplink scheduling and downlink scheduling.

### (Supplementary Note 45)

The RU according to Supplementary Note 44, wherein the means for sending is configured to send the information indicating the uplink SRS resource allocation to the DU in response to receiving a request from the DU.

### (Supplementary Note 46)

The RU according to Supplementary Note 22, wherein the means for sending is configured to autonomously send the information indicating the uplink SRS resource allocation to the DU in response to an update of the uplink SRS resource allocation.

### (Supplementary Note 47)

The RU according to any one of Supplementary Notes 44 to 46, wherein the means for sending is configured to send the information indicating the uplink SRS resource allocation to the DU via a control plane message in the fronthaul interface.

### (Supplementary Note 48)

The RU according to any one of Supplementary Notes 44 to 47, further comprising means for receiving, from the DU, information indicating a resource allocation to the UE.

### (Supplementary Note 49)

The RU according to Supplementary Note 48, wherein the means for dynamically allocating is configured to determine uplink SRS resources to be allocated to the UE using the information indicating the resource allocation.

### (Supplementary Note 50)

The RU according to any one of Supplementary Notes 44 to 49, wherein
the RU is an O-RAN Radio Unit conforming to Open Radio Access Network (O-RAN) technical specifications, and
the DU is an O-RAN Distributed Unit conforming to the O-RAN technical specifications.

### (Supplementary Note 51)

A method performed by a Radio Unit (RU), the method comprising:
performing low physical layer signal processing;
communicating via a fronthaul interface with a Distributed Unit (DU) configured to perform high physical layer signal processing;
dynamically allocating uplink Sounding Reference Signal (SRS) resources to a User Equipment (UE); and
sending information indicating an uplink SRS resource allocation for the UE to the DU configured to perform at least one of uplink scheduling and downlink scheduling.

### (Supplementary Note 52)

A distributed unit (DU) comprising:
means for communicating via a fronthaul interface with a Radio Unit (RU) configured to perform low physical layer signal processing;
means for performing high physical layer signal processing;
means for performing at least one of uplink scheduling and downlink scheduling; and
means for sending information indicating a resource allocation for a User Equipment (UE), obtained by the at least one of the uplink scheduling and the downlink scheduling, to the RU or a Central Unit (CU) configured to perform dynamic uplink Sounding Reference Signal (SRS) resource allocation to the UE.

### (Supplementary Note 53)

The DU according to Supplementary Note 52, wherein the means for sending is configured to send the information indicating the resource allocation to the RU via a control plane message in the fronthaul interface.

### (Supplementary Note 54)

The DU according to Supplementary Note 52 or 53, wherein the information indicating the resource allocation is used by the RU or the CU to determine uplink SRS resources to be allocated to the UE.

### (Supplementary Note 55)

The DU according to any one of Supplementary Notes 52 to 54, wherein
the RU is an O-RAN Radio Unit conforming to Open Radio Access Network (O-RAN) technical specifications,
the DU is an O-RAN Distributed Unit conforming to the O-RAN technical specifications, and
the CU is an O-RAN Central Unit conforming to the O-RAN technical specifications.

### (Supplementary Note 56)

A method performed by a Distributed Unit (DU), the method comprising: communicating via a fronthaul interface with a Radio Unit (RU) configured to perform low physical layer signal processing;
performing high physical layer signal processing;
performing at least one of uplink scheduling and downlink scheduling; and
sending information indicating a resource allocation for a User Equipment (UE) to the RU or a Central Unit (CU) configured to perform dynamic uplink Sounding Reference Signal (SRS) resource allocation to the UE.

### (Supplementary Note 57)

A program for causing a computer to perform a method for a Distributed Unit (DU), the method comprising:
communicating via a fronthaul interface with a Radio Unit (RU) configured to perform low physical layer signal processing;
performing high physical layer signal processing;
performing at least one of uplink scheduling and downlink scheduling; and
sending information indicating a resource allocation for a User Equipment (UE) to the RU or a Central Unit (CU) configured to perform dynamic uplink Sounding Reference Signal (SRS) resource allocation to the UE.

### (Supplementary Note 58)

A Radio Unit (RU) comprising:
means for performing low physical layer signal processing;
means for communicating via a fronthaul interface with a Distributed Unit (DU) configured to perform high physical layer signal processing;
means for dynamically allocating uplink Sounding Reference Signal (SRS) resources to a User Equipment (UE); and
means for receiving information from the DU indicating a resource allocation to the UE.

### (Supplementary Note 59)

The RU according to Supplementary Note 58, wherein the means for receiving is configured to receive the information indicating the resource allocation from the DU via a control plane message in the fronthaul interface.

### (Supplementary Note 60)

The RU according to Supplementary Note 58 or 59, wherein the means for dynamically allocating is configured to determine uplink SRS resources to be allocated to the UE using the information indicating the resource allocation.

### (Supplementary Note 61)

The RU according to any one of Supplementary Notes 58 to 60, wherein
the RU is an O-RAN Radio Unit conforming to Open Radio Access Network (O-RAN) technical specifications, and
the DU is an O-RAN Distributed Unit conforming to the O-RAN technical specifications.

### (Supplementary Note 62)

A method performed by a Radio Unit (RU), the method comprising:
performing low physical layer signal processing;
communicating via a fronthaul interface with a Distributed Unit (DU) configured to perform high physical layer signal processing;
dynamically allocating uplink Sounding Reference Signal (SRS) resources to a User Equipment (UE); and
receiving information from the DU indicating a resource allocation to the UE.

### (Supplementary Note 63)

A base station system comprising:
a Radio Unit (RU) configured to perform low physical layer signal processing;
a Distributed Unit (DU) configured to perform high physical layer signal processing; and
a controller configured to perform near-real-time control of radio access network elements and resources, including at least the DU, wherein
the at least one of the RU, the DU, and the controller is configured to perform both channel estimation and channel prediction.

### (Supplementary Note 64)

The base station system according to Supplementary Note 63, wherein the one configured to perform the channel estimation and the channel prediction is the RU.

### (Supplementary Note 65)

The base station system according to Supplementary Note 64, wherein the RU is further configured to perform at least one of uplink beamforming and downlink beamforming.

### (Supplementary Note 66)

The base station system according to Supplementary Note 65, wherein the performing at least one of uplink beamforming and downlink beamforming includes calculating a corresponding beamforming weight.

### (Supplementary Note 67)

The base station system according to Supplementary Note 65 or 66, wherein the RU is configured to perform the at least one of uplink beamforming and downlink beamforming using a result of one or a combination of a Sounding Reference Signal (SRS)-based channel prediction and an uplink Demodulation Reference Signal (DMRS)-based channel prediction.

### (Supplementary Note 68)

The base station system according to any one of Supplementary Notes 63 to 67, wherein
the RU is an O-RAN Radio Unit conforming to Open Radio Access Network (O-RAN) technical specifications,
the DU is an O-RAN Distributed Unit conforming to the O-RAN technical specifications, and
the controller is a Near-Real-Time RAN Intelligent Controller conforming to the O-RAN technical specifications.

### (Supplementary Note 69)

The base station system according to any one of Supplementary Notes 63 to 68, wherein
the channel estimation comprises estimating channel characteristics between a User Equipment (UE) and the RU using a result of reception of at least one of a Sounding Reference Signal (SRS) and an uplink Demodulation Reference Signal (DMRS) transmitted by the UE, and
the channel prediction comprises a temporal prediction, using a result of the channel estimation, of the channel characteristics, eigenvectors for downlink transmission to the UE, precoding weights for the downlink transmission, beamforming weights for the downlink transmission, or downlink beams for the downlink transmission.

### (Supplementary Note 70)

The base station system according to any one of Supplementary Notes 63 to 69, wherein the channel prediction comprises predicting at least one of:
(a) Channel state information (CSI);
(b) Channel quality indicator (CQI);
(c) Rank indicator (RI);
(d) Eigenvectors of channel response matrix;
(e) Signal to interference and noise ratio (SINR);
(f) Precoding matrix indicator (PMI);
(g) Angle of arrival (AoA); and
(h) Angle of departure (AoD).

### (Supplementary Note 71)

The base station system according to any one of Supplementary Notes 63 to 70, wherein the DU is configured to perform at least one of uplink scheduling, downlink scheduling and dynamic uplink SRS resource allocation.

### (Supplementary Note 72)

The base station system according to any one of Supplementary Notes 63 to 71, wherein the DU is configured to (a) perform at least one of uplink scheduling and downlink scheduling; and to (b) receive information from the RU or a Central Unit (CU) indicating an uplink SRS resource allocation dynamically determined by the RU or the CU.

### (Supplementary Note 73)

The base station system according to any one of Supplementary Notes 63 to 72, wherein the DU is configured to perform uplink scheduling based on at least one of dynamic scheduling and configured scheduling.

### (Supplementary Note 74)

The base station system according to any one of Supplementary Notes 63 to 73wherein the DU is configured to perform downlink scheduling based on at least one of dynamic scheduling and semi-persistent scheduling.

### (Supplementary Note 75)

The base station system according to any one of Supplementary Notes 63 to 74, wherein the prediction is done by using at least one of AI/ML-based and non-AI/ML-based methods.

### (Supplementary Note 76)

The base station system according to Supplementary Note 75, wherein the AI/ML-based method uses an AI/ML model based on at least one of RNN, LSTM, CNN, transformer model, ML-mixer, FCN, and auto-regression model.

### (Supplementary Note 77)

The base station system according to Supplementary Note 75, wherein the non-AI/ML-based method includes at least one of sample-and-hold method, Wiener filter method, Kalman filter method, Burg method, and Yule-Walker method.

### (Supplementary Note 78)

The base station system according to any one of Supplementary Notes 63 to 77, wherein the DU and the RU are configured to exchange information including at least one of:
(a) Sounding Reference Signal (SRS) configuration parameters;
(b) Channel estimation parameters;
(c) Channel prediction parameters;
(d) Dynamic SRS scheduling parameters; and
(e) Data scheduling parameters.

### (Supplementary Note 79)

The base station system according to Supplementary Note 78, wherein the SRS configuration parameters include at least one of:
(a) SRS time-domain position;
(b) SRS frequency-domain position;
(c) SRS bandwidth;
(d) SRS period;
(e) Cyclic shift;
(f) Transmission comb;
(g) Time offset;
(h) Frequency offset; and
(i) Number of SRS ports.

### (Supplementary Note 80)

The base station system according to Supplementary Note 78, wherein the channel estimation parameters include at least one of:
(a) Channel estimation method;
(b) Channel estimation granularity in frequency domain;
(c) Window type; and
(d) Window size.

### (Supplementary Note 81)

The base station system according to Supplementary Note 80, wherein the channel estimation method includes at least one of:
(a) LS algorithm;
(b) MMSE algorithm;
(c) DFT-based algorithm; and
(d) DCT-based algorithm.

### (Supplementary Note 82)

The base station system according to Supplementary Note 78, wherein the channel prediction parameters include at least one of:
(a) A channel prediction configuration; and
(b) A requested channel prediction output.

### (Supplementary Note 83)

The base station system according to Supplementary Note 82, wherein the channel prediction configuration includes at least one of:
(a) An indicator to indicate at least one of AI/ML-based prediction and non-AI/ML-based prediction methods;
(b) A prediction method from a predefined list of prediction methods; and
(c) A prediction model setup parameters.

### (Supplementary Note 84)

The base station system according to Supplementary Note 82, wherein the requested channel prediction output includes at least one of:
(a) CSI;
(b) CQI;
(c) Eigenvector;
(d) RI;
(e) PMI;
(f) AoA;
(g) AoD; and
(h) SINR.

### (Supplementary Note 85)

The base station system according to Supplementary Note 78, wherein the dynamic SRS scheduling parameters include at least one of:
(a) SRS time-domain position;
(b) SRS frequency-domain position;
(c) SRS bandwidth;
(d) SRS period;
(e) Cyclic shift;
(f) Transmission comb;
(g) Time offset;
(h) Frequency offset; and
(i) Number of SRS ports.

### (Supplementary Note 86)

The base station system according to Supplementary Note 78, wherein the data scheduling parameters include at least one of:
(a) PUSCH transmission resource;
(b) PDSCH transmission resource;
(c) PUCCH transmission resource; and
(d) PDCCH transmission resource.

### (Supplementary Note 87)

The base station system according to Supplementary Note 78, wherein the information is exchanged by at least one of:
(a) A new C-Plane Section Type X; and
(b) A new Section Extension.

### (Supplementary Note 88)

A Radio Unit (RU) comprising:
means for performing low physical layer signal processing;
means for communicating via a fronthaul interface with a Distributed Unit (DU) configured to perform high physical layer signal processing; and
means for performing channel estimation and channel prediction.

### (Supplementary Note 89)

A Radio Unit (RU) comprising:
means for performing low physical layer signal processing;
means for communicating via a fronthaul interface with a Distributed Unit (DU) configured to perform high physical layer signal processing; and
means for performing Sounding Reference Signal (SRS)-based channel estimation and channel prediction.

### (Supplementary Note 90)

A method performed by a Radio Unit (RU), the method comprising:
performing low physical layer signal processing;
communicating via a fronthaul interface with a Distributed Unit (DU) configured to perform high physical layer signal processing; and
means for performing channel estimation and channel prediction.

### (Supplementary Note 91)

A method performed by a Radio Unit (RU), the method comprising: performing low physical layer signal processing;
communicating via a fronthaul interface with a Distributed Unit (DU) configured to perform high physical layer signal processing; and
performing Sounding Reference Signal (SRS)-based channel estimation and channel prediction.

### (Supplementary Note 92)

A base station system comprising:
a Radio Unit (RU) configured to perform low physical layer signal processing;
a Distributed Unit (DU) configured to perform high physical layer signal processing;
a first controller configured to perform near-real-time control of radio access network elements and resources, including at least the DU, wherein
the at least one of the RU, the DU, and the first controller is configured to perform both channel estimation and channel prediction; and
a second controller configured to determine where should the channel estimation and the channel prediction be performed among the at least one of the RU, the DU, and the first controller based on at least one predetermined condition.

### (Supplementary Note 93)

The base station system according to Supplementary Note 92, wherein both the DU and the RU are configured with the ability to perform the channel estimation and the channel prediction, but only one between the DU and the RU is enabled by the second controller to perform the channel estimation and the channel prediction based on the at least one predetermined condition.

### (Supplementary Note 94)

The base station system according to Supplementary Notes 92 or 93, wherein the channel estimation comprises at least one of a Sounding Reference Signal (SRS)-based channel estimation and an uplink Demodulation Reference Signal (DMRS)-based channel estimation.

### (Supplementary Note 95)

The base station system according to any one of Supplementary Notes 92 to 94, wherein the channel prediction comprises at least one of a Sounding Reference Signal (SRS)-based channel prediction and an uplink Demodulation Reference Signal (DMRS)-based channel prediction.

### (Supplementary Note 96)

The base station system according to any one of Supplementary Notes 92 to 95, wherein the predetermined condition is based on at least one of OFH traffic, latency, and OFH capacity.

1. A method performed by a Radio Unit (RU), the method comprising:
performing low physical layer signal processing;
communicating via a fronthaul interface with a Distributed Unit (DU) configured to perform high physical layer signal processing; and
performing channel estimation and channel prediction.

2. The method according to claim 1, further comprising performing precoding for downlink transmission.

3. The method according to claim 2, wherein the performing the precoding comprises performing the precoding using a result of the channel prediction.

4. The method according to claim 1, wherein
the RU is an O-RAN Radio Unit conforming to Open Radio Access Network (O-RAN) technical specifications, and
the DU is an O-RAN Distributed Unit conforming to the O-RAN technical specifications.

5. The method according to claim 1, wherein
the channel estimation comprises estimating channel characteristics between a User Equipment (UE) and the RU using a result of reception of at least one of a Sounding Reference Signal (SRS) and an uplink Demodulation Reference Signal (DMRS) transmitted by the UE, and
the channel prediction comprises a temporal prediction, using a result of the channel estimation, of the channel characteristics, eigenvectors for downlink transmission to the UE, precoding weights for the downlink transmission, beamforming weights for the downlink transmission, or downlink beams for the downlink transmission.

6. The method according to claim 1, further comprising performing dynamic allocation of uplink Sounding Reference Signal (SRS) resources.

7. The method according to claim 6, wherein the communicating comprises sending information indicating dynamically determined uplink SRS resource allocation via the fronthaul interface to the DU configured to perform scheduling of one or both of uplink resources and downlink resources.

8. The method according to claim 7, wherein the communicating comprises sending the information indicating the uplink SRS resource allocation to the DU in response to receiving a request from the DU.

9. The method according to claim 7, wherein the communicating comprises autonomously sending the information indicating the uplink SRS resource allocation to the DU in response to an update of the uplink SRS resource allocation.

10. The method according to claim 6, wherein the communicating comprises receiving information indicating a resource allocation for a User Equipment (UE) from the DU via the fronthaul interface.

11. The method according to claim 10, wherein the performing dynamic allocation of uplink SRS resources comprises allocating uplink SRS resources to the UE using the information indicating the resource allocation.

12. A Radio Unit (RU) comprising:
at least one memory; and
at least one processor coupled to the at least one memory and configured to:
perform low physical layer signal processing;
communicate via a fronthaul interface with a Distributed Unit (DU) configured to perform high physical layer signal processing; and
perform channel estimation and channel prediction.

13. The RU according to claim 12, wherein the at least one processor is further configured to perform precoding for downlink transmission.

14. The RU according to claim 13, wherein the at least one processor is configured to perform the precoding using a result of the channel prediction.

15. The RU according to claim 12, wherein
the RU is an O-RAN Radio Unit conforming to Open Radio Access Network (O-RAN) technical specifications, and
the DU is an O-RAN Distributed Unit conforming to the O-RAN technical specifications.

16. The RU according to claim 12, wherein
the channel estimation comprises estimating channel characteristics between a User Equipment (UE) and the RU using a result of reception of at least one of a Sounding Reference Signal (SRS) and an uplink Demodulation Reference Signal (DMRS) transmitted by the UE, and
the channel prediction comprises a temporal prediction, using a result of the channel estimation, of the channel characteristics, eigenvectors for downlink transmission to the UE, precoding weights for the downlink transmission, beamforming weights for the downlink transmission, or downlink beams for the downlink transmission.

17. The RU according to claim 12, wherein the at least one processor is further configured to perform dynamic allocation of uplink Sounding Reference Signal (SRS) resources.

18. The RU according to claim 17, wherein the at least one processor is configured to send information indicating dynamically determined uplink SRS resource allocation via the fronthaul interface to the DU configured to perform scheduling of one or both of uplink resources and downlink resources.

19. The RU according to claim 18, wherein the at least one processor is configured to send the information indicating the uplink SRS resource allocation to the DU in response to receiving a request from the DU.

20. A base station system comprising:
a Radio Unit (RU) configured to perform low physical layer signal processing;
a Distributed Unit (DU) configured to perform high physical layer signal processing; and
a controller configured to perform near-real-time control of radio access network elements and resources, including at least the DU, wherein
the at least one of the RU, the DU, and the controller is configured to perform both channel estimation and channel prediction.
